(19) United States
(12) Patent Application Publication
(10) Pub. No.: US 2019/0069249 A1
(43) Pub. Date: Feb. 28, 2019

(54) COMMUNICATION SYSTEM

(71) Applicant: NEC CORPORATION, Tokyo (JP)

(72) Inventors: Takahiro YAZAKI, Tokyo (JP); Junichi YAHAGI, Tokyo (JP)

(73) Assignee: NEC CORPORATION, Tokyo (JP)

(21) Appl. No.: 16/043,940

(22) Filed: Jul. 24, 2018

(30) Foreign Application Priority Data
Aug. 23, 2017 (JP) 2017-160255

(51) Int. Cl. H04W 52/14; H04W 72/04; H04W 52/24; H04W 52/36; H04W 72/14; H04L 1/00

(52) U.S. Cl. CPC H04W 52/146; H04W 72/042; H04W 72/0453; H04L 1/0009; H04W 52/365; H04W 72/14; H04L 1/0003; H04W 52/242

(57) ABSTRACT

In order to carry out power control and modulation coding control more appropriately, a communication system includes: a division unit that divides a frequency band assigned to wireless communication which is carried out between first communication equipment and second communication equipment, and generates a partial band that is generated by the division; a path loss derivation unit that derives a propagation loss, which relates to the communication, in at least one of the partial bands; a control information derivation unit that derives control information from the propagation loss; and a control unit that carries out transmission power control and/or modulation coding control based on the control information.

This application is based upon and claims the benefit of priority from Japanese Patent Application No. 2017-160255, filed on Aug. 23, 2017, the disclosure of which is incorporated herein in its entirety by reference.

### TECHNICAL FIELD

The present invention relates to a control method of wireless communication.

### BACKGROUND ART

In 3GPP, as a mobile communication system realizing high speed data communication, a study on a next-generation communication specification following LTE and LTE-Advanced has been progressed. Here, 3GPP is abbreviation of 3rd Generation Partnership Project. Moreover, LTE is abbreviation of Long Term Evolution, and LTE-Advance is abbreviation of Long Term Evolution Advanced. The next-generation communication specification is, for example, a communication standard for 5G (5th Generation).

According to a non-patent literature (NPL) 1, it is required in the communication standard for 5G that a system capacity is 1,000 or more times as large as that of LTE, and a user sensible data transmission speed is approximately 100 times as fast as that of LTE, and a delay time is short so as to be 1 msec or shorter than 1 msec. Moreover, according to the NPL 1, it is required in the communication standard for 5G that number of simultaneous terminal-connections is 100 or more times as large as that of LTE, and a cost and power consumption are lowered 100 or more times. In order to meet the required conditions, it has been studied to make a frequency bandwidth wider than a frequency bandwidth used in LTE.

Here, when a mobile station transmits information to a base station in the case of LTE, PUSCH is used as one of physical channels. Here, PUSCH is abbreviation of Physical Uplink Shared Channel, and means a shared channel of a physical uplink.

A power value of PUSCH is controlled according to a formula 1 which is expressed as the following (refer to a NPL 2).

$${P}_{PUSCH , c} ( i ) = min \{ \begin{matrix}{P}_{CMAX , c} ( i ) , \\ 10 {log}_{10} ( {M}_{PUSCH , c} ( i ) ) + {P}_{{O}_{—} PUSCH , c} ( j ) + {α}_{c} ( j ) \cdot {PL}_{c} + {Δ}_{TF , c} ( i ) + {f}_{c} ( i )\end{matrix} \} \qquad Formula 1$$

A subscript c in the formula 1 expresses a serving cell, and an index i expresses a sub-frame number. Moreover, P_{PUSCH,c} (i) is a transmission power value of PUSCH, and P_{CMAX,c} is a maximum transmission power value. Moreover, M_{PUSCH,c} (i) is number of resource blocks of PUSCH. Moreover, P_{O}_{_}_{PUSCH,c} (j) is transmission power which is specific to the cell and which is a base of PUSCH. Moreover, α_{c} (j) is a compensation coefficient which is multiplied by a propagation loss (path loss), and PL_{c} is the path loss. Moreover, Δ_{TF,c} (i) is an offset value which is caused by a modulation method or the like. Moreover, f_{c} (i) is an accumulation value of a TPC command which relates to PUSCH and which is instructed by the base station. Here, TPC is abbreviation of Transmit Power Control.

The mobile station reports its own available transmission power to the base station using PHR. Here, PHR is abbreviation of Power Headroom Report.

When signals are not transmitted through PUSCH and PUCCH at the same time, a value of PHR which the mobile station reports to the base station is expressed as the following formula 2. Here, PUCCH is abbreviation of Physical Uplink Control Channel, and means a control channel of the physical uplink (refer to the NPL 2).

PH_{type1,c}(i)=P_{CMAX,c}(i)−{10 log₁₀(M_{PUSCH,c}(i))+P_{O}_{_}_{PUSCH,c}(j)+α_{c}(j)·PL_{c}+Δ_{TF,c}(i)+f_{c}(i)} Formula 2

Here, P_{CMAX,c}, M_{PUSCH,c} (i), P_{O}_{_}_{PUSCH,c}(j), α_{c} (j), PL_{c}, Δ_{TF,c} (i), and f_{c} (i) have been mentioned above.

Meanwhile, the TPC command and MCS which are set in the base station are reported together with uplink resource assignment and the like to the base station through PDCCH as DCI. Here, MCS is abbreviation of Modulation and Coding Scheme. Moreover, DCI is abbreviation of Downlink Control Information. Moreover, PDCCH is abbreviation of Physical Downlink Control Channel, and means a control channel of a physical downlink.
[NPL 1] DOCOMO 5G white paper “A required condition and a technical concept in the 5G wireless access after year of 2020”, NTT DOCOMO, INC., September, 2014, [retrieved on Jul. 19, 2017], Internet (https://www.nttdocomo.co.jp/binary/pdf/corporate/technology/whitepaper_5g/D OCOMO_5G_White_PaperJP_20141006.pdf)
[NPL 2] 3GPP TS 36.213 V13.4.0 (2016-12), [retrieved on Jul. 19, 2017], Internet (http://www.3gpp.org/ftp/Specs/2016-12/Rel-13/36_series/36213-d40.zip)

Generally, a value of the path loss is changed according to a frequency since channel interference, a propagation loss in the free space, and the like are changed according to the frequency. Therefore, when the frequency bandwidth is wider than the bandwidth of LTE as assumed in the case of 5G, there is a high level possibility that a large difference in the value of the path loss is caused according to a communication frequency, at which communication is carried out actually, even if the communication frequency is in a predetermined frequency band.

The NPL 2 describes that the mobile station derives PHR from one path loss for each frequency band. However, a value of the path loss is different according to the communication frequency which is used actually even if the communication frequency is within a certain frequency band. Moreover, when the frequency bandwidth becomes wide, there is an increasing possibility that the path loss of the communication frequency (hereinafter, referred to as “actual frequency”) which is used actually deviates from the derived path loss.

The base station determines the TPC command and MCS (Modulation and Coding Scheme) based on PHR. Then, the base station makes the mobile station carry out power control and modulation coding control based on the TPC command and MCS. Therefore, when receiving the derived PHR which is derived from the derived path loss deviating from the path loss caused at the actual frequency and which deviates from PHR that should be right at the actual frequency, the base station cannot make the mobile station carry out the power control and the modulation coding control correctly. That is, when the frequency bandwidth becomes wide, there is an increasing possibility that the communication system cannot carry out the power control and the modulation coding control correctly.

### SUMMARY

An object of the present invention is to provide a communication system and the like which carry out the power control and the modulation coding control more appropriately.

A communication system includes: a division unit that divides a frequency band assigned to wireless communication which is carried out between first communication equipment and second communication equipment, and generates a partial band which is a frequency band generated by the division; a path loss derivation unit that derives a propagation loss, which relates to the communication, in at least one of the partial bands; a control information derivation unit that derives control information from the propagation loss; and a control unit that carries out transmission power control and/or modulation coding control based on the control information.

The communication system of the present invention, and the like can carry out the power control and the modulation coding control more appropriately.

### BRIEF DESCRIPTION OF THE DRAWINGS

Exemplary features and advantages of the present invention will become apparent from the following detailed description when taken with the accompanying drawings in which:

FIG. 1 is a conceptual diagram illustrating an example of a configuration of a communication system of a present example embodiment;

FIG. 2 is a conceptual diagram illustrating an example of a configuration of a processing unit of a base station;

FIG. 3 is a conceptual diagram illustrating an example of a configuration of a processing unit of a mobile station;

FIG. 4 is a conceptual diagram illustrating an example of a configuration of a processing unit whose function unit is divided in a unit of a partial band;

FIG. 5 is a sequence chart illustrating an example of processes which are carried out by the processing units of the base station and the mobile station;

FIG. 6 is a conceptual diagram illustrating an example of a flow of processes which are carried out by a division unit;

FIG. 7 is a conceptual diagram illustrating an example of a flow of processes which are carried out by a path loss derivation unit;

FIG. 8 is a conceptual diagram illustrating an example of a flow of processes which are carried out by a PHR derivation unit;

FIG. 9 is a conceptual diagram illustrating an example of a flow of processes which are carried out by a UL grant determination unit;

FIG. 10 is a conceptual diagram illustrating an example of a flow of processes which are carried out by a UL grant updating unit;

FIG. 11 is a conceptual diagram illustrating an example of a flow of processes which are carried out by a TPC command accumulation unit;

FIG. 12 is a conceptual diagram illustrating an example of a flow of processes which are carried out by a power control unit;

FIG. 13 is a conceptual diagram illustrating an example of a flow of processes which are carried out by a modulation coding control unit;

FIG. 14 is an image diagram illustrating an example of a UL grant in which sub UL grants different from each other are set and updated in the unit of the partial band;

FIG. 15 is an image diagram illustrating an example of the UL grant in which the sub UL grant common to the plural partial bands is set and updated;

FIG. 16 is an image diagram illustrating an example of the UL grant in which information assigned to the sub UL grant existing under a boundary frequency is different from information assigned to the sub UL grant existing over the boundary frequency;

FIG. 17 is an image diagram illustrating an example of the UL grant in which the partial band for TPC command, and the partial band for MCS are set individually;

FIG. 18 is an image diagram illustrating an example of the UL grant in which only the predetermined sub grant is updated;

FIG. 19 is a conceptual diagram illustrating an example of the processing unit of the mobile station which can derive division information independently of the base station's deriving division information; and

FIG. 20 is a conceptual diagram illustrating a minimum configuration of the communication system of the present example embodiment.

### EXAMPLE EMBODIMENT

Next, a detailed explanation will be given for a first example embodiment with reference to the drawings.

[Configuration and Operation]

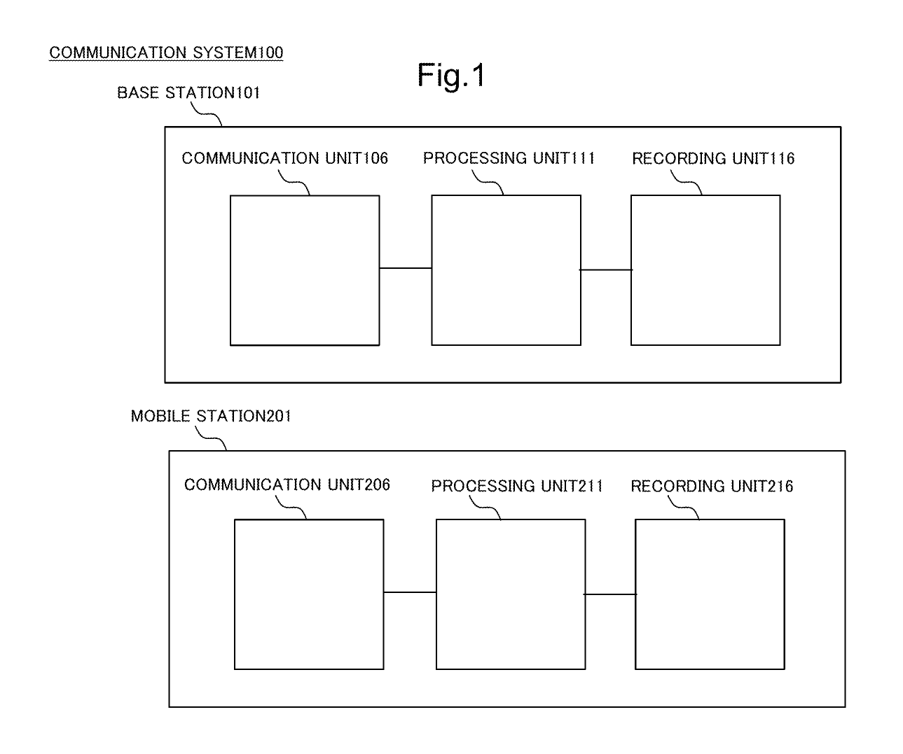

FIG. 1 is a conceptual diagram illustrating a configuration of a communication system 100 which is an example of a communication system of a present example embodiment.

The communication system 100 includes a base station 101 and a mobile station 201.

The base station 101 includes a communication unit 106, a processing unit 111, and a recording unit 116.

The mobile station 201 includes a communication unit 206, a processing unit 211, and a recording unit 216.

The communication unit 106 transmits information, which is transmitted by the processing unit 111, toward the mobile station 201 through a wireless circuit according to an instruction of the processing unit 111. The communication unit 106 receives information which is transmitted by the mobile station 201 through the wireless circuit, and transmits reception information, which is the received information, to the processing unit 111. The reception information includes PHR (each PHR) on each frequency band (each partial band) which is generated by division. Here, PHR will be mentioned later.

The processing unit 111 divides a frequency band which is read from the recording unit 116. Here, the frequency band is a frequency band which is assigned to communication carried out between the base station 101 and the mobile station 201. The processing unit 111 makes the recording unit 116 record division information which is information indicating a frequency band (partial band) generated by the division. The division information is, for example, information indicating a minimum frequency and a maximum frequency of each partial band into which the frequency band used for communication between the base station 101 and the mobile station 201 is divided and which is generated by the division.

Moreover, the processing unit 111 derives a UL grant from PHR on each partial band which is received from the mobile station 201. Here, PHR is the same as PHR which has been explained already in Background Art. Moreover, UL is abbreviation of Up Link. The UL grant includes a sub UL grant which is the UL grant on each partial band. The sub UL grant includes a sub TPC command which is a TPC command on the partial band, and a sub MCS which is MCS on the partial band. The UL grant, the TPC command, and MCS are described by the NPL 2.

The processing unit 111 makes the communication unit 206 transmit various kinds of transmission information to the communication unit 106. The transmission information includes the division information and the UL grant which are mentioned above.

Moreover, the processing unit 111 carries out a predetermined process to the information which is transmitted by the communication unit 106. The above-mentioned process includes derivation of the above-mentioned UL grant.

According to an instruction of the processing unit 111, the recording unit 116 records designated information. Moreover, according to an instruction of the processing unit 111, the recording unit 116 transmits designated information to the processing unit 111.

The communication unit 206 of the mobile station 201 transmits information, which is transmitted by the processing unit 211, toward the mobile station 201 through the wireless circuit according to an instruction of the processing unit 211. The communication unit 206 receives information which is transmitted by the communication unit 206 through the wireless circuit, and transmits the received information (reception information) to the processing unit 211. The reception information includes the above-mentioned UL grant.

The processing unit 211 makes the recording unit 216 record the above-mentioned division information which is transmitted by the base station 101. Moreover, the processing unit 211 derives a path loss (each path loss) which is a propagation loss of each partial band. A method of deriving the path loss is described by the NPL 2. The processing unit 211 makes the recording unit 216 record each derived path loss.

Moreover, the processing unit 211 derives PHR (each PHR) on each partial band from each path loss. The processing unit 211 makes the recording unit 216 record each derived PHR. Furthermore, the processing unit 211 makes the communication unit 206 transmit each derived PHR toward the base station 101.

Moreover, the processing unit 211 derives a TPC command accumulation value (each TPC command accumulation value) of each partial band from each TPC command which is included in the UL grant transmitted by the base station 101. The TPC command is given in a form of a numerical value. The TPC command and the TPC command accumulation value are described by NPL 2. Then, the processing unit 211 carries out control of transmission power (transmission power control), which is used when the communication unit 206 carries out transmission using a frequency of each partial band, based on each path loss and each TPC command accumulation value. A method of controlling the transmission power is described by the NPL 2.

Moreover, the processing unit 211 carries out control of modulation coding (modulation coding control) of each partial band, which is carried out when the communication unit 206 carries out transmission, based on MCS of each partial band which is included in the UL grant transmitted by the base station 101. A method of controlling the modulation coding is described by the NPL 2.

The processing unit 211 makes the communication unit 206 transmit various kinds of information for transmission. The information for transmission includes each PHR which is mentioned above.

Moreover, in some cases, the processing unit 211 carries out a process other than the above-mentioned process to the information which is transmitted by the communication unit 206.

According to an instruction of the processing unit 211, the recording unit 216 records designated information. Moreover, according to an instruction of the processing unit 211, the recording unit 216 transmits designated information to the processing unit 211.

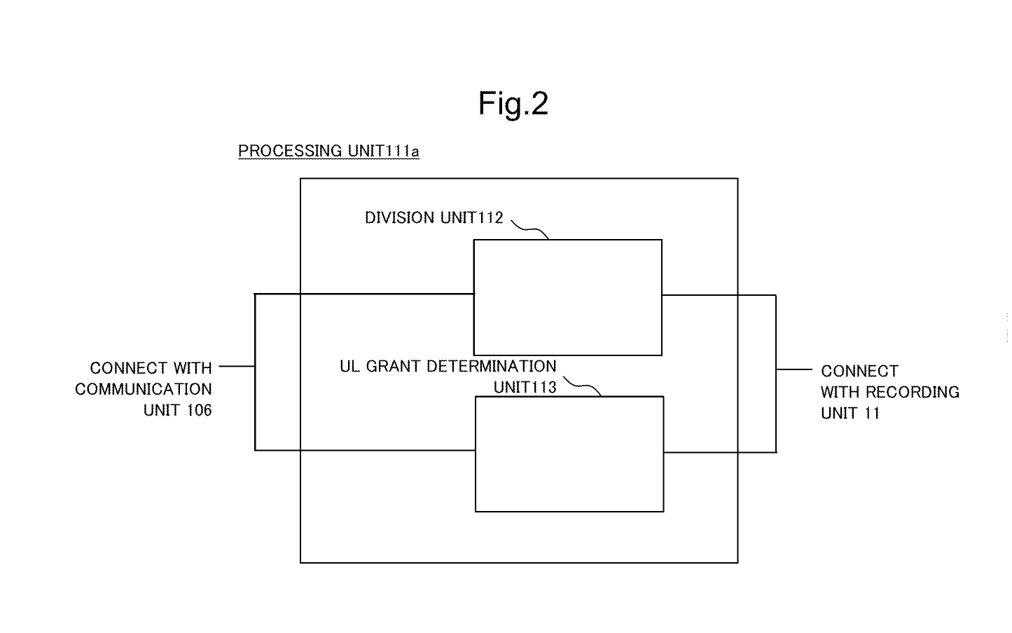

FIG. 2 is a conceptual diagram illustrating a configuration of a processing unit 111a which is an example of the processing unit 111 of the base station 101 illustrated in FIG. 1.

The processing unit 111a includes a division unit 112 and a UL grant determination unit 113.

The division unit 112 divides the above-mentioned frequency band which is read from the recording unit 116, and derives the plural partial bands. The division unit 112 makes the recording unit 116 record the division information which is information indicating each partial band.

The UL grant determination unit 113 derives the UL grant from PHR which is received from the mobile station 201 illustrated in FIG. 1. The UL grant includes the TPC command and MCS on each partial band. The UL grant determination unit 113 makes the recording unit 116 record the derived UL grant. Moreover, the UL grant determination unit 113 makes the communication unit 106 transmit the derived UL grant toward the mobile station 201 which is illustrated in FIG. 1.

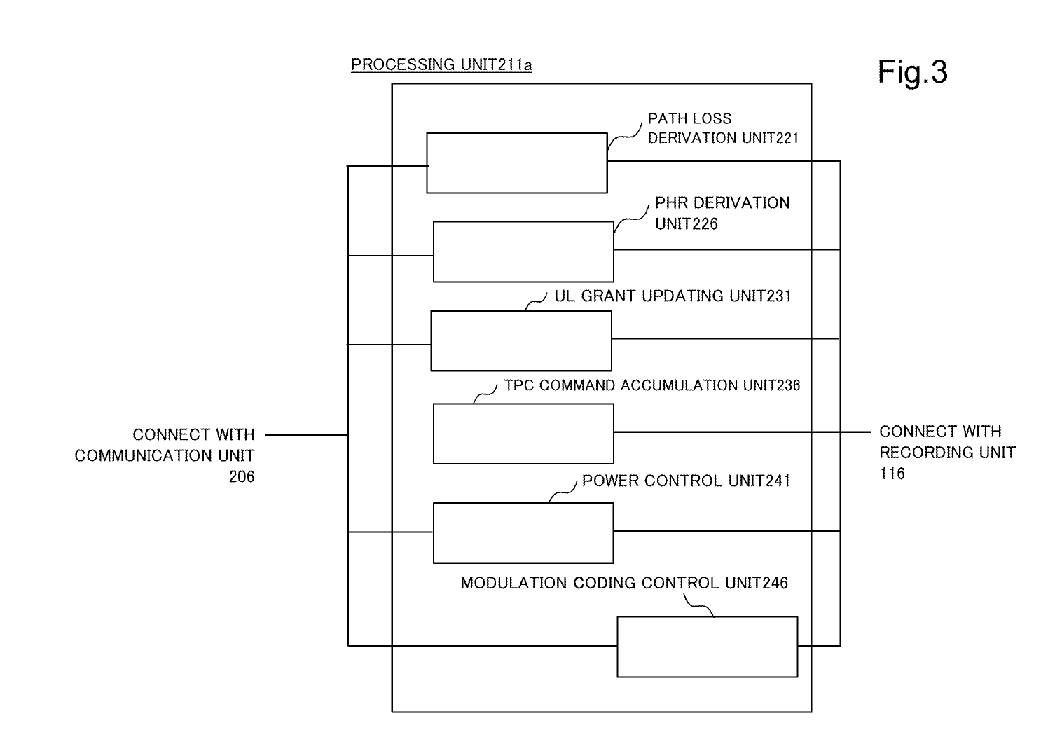

FIG. 3 is a conceptual diagram illustrating a configuration of a processing unit 211a which is an example of the processing unit 211 of the mobile station 201 illustrated in FIG. 1.

The processing unit 211a includes a path loss derivation unit 221, a PHR derivation unit 226, a UL grant updating unit 231, a TPC command accumulation unit 236, a power control unit 241, and a modulation coding control unit 246.

The path loss derivation unit 221 makes the recording unit 216 record the above-mentioned division information which is transmitted by the base station 101. Moreover, the path loss derivation unit 221 derives the path loss (each path loss) on each partial band. Each path loss is, for example, a path loss at a center frequency of each partial band. The path loss derivation unit 221 makes the recording unit 216 record each derived path loss.

The PHR derivation unit 226 reads each path loss mentioned above from the recording unit 116. Then, the PHR derivation unit 226 derives each PHR mentioned above from each path loss. The PHR derivation unit 226 makes the recording unit 216 record each derived PHR. Furthermore, the PHR derivation unit 226 makes the communication unit 206 transmit each derived PHR toward the base station 101.

The TPC command accumulation unit 236 derives each TPC command accumulation value mentioned above from each TPC command which is included in the UL grant transmitted by the base station 101. Then, the processing unit 211 carries out the control of the transmission power, which relates to transmission carried out by the communication unit 206 using a frequency of each partial band, based on each path loss and each TPC command accumulation value. A method of controlling the transmission power is described by the NPL 2.

Moreover, the processing unit 211 carries out the above-mentioned modulation coding control, which is carried out when the communication unit 206 carries out transmission, based on MCS of each partial band which is included in the UL grant transmitted by the base station 101. A method of controlling the modulation coding is described by the NPL 2.

The processing unit 211a, which is illustrated in FIG. 3, may divide a function unit in a unit of the partial band which is generated by the division, and carry out the process in a unit of the partial band. Here, it is assumed that the function unit includes the path loss derivation unit 221, the PHR derivation unit 226, and the TPC command accumulation unit 236.

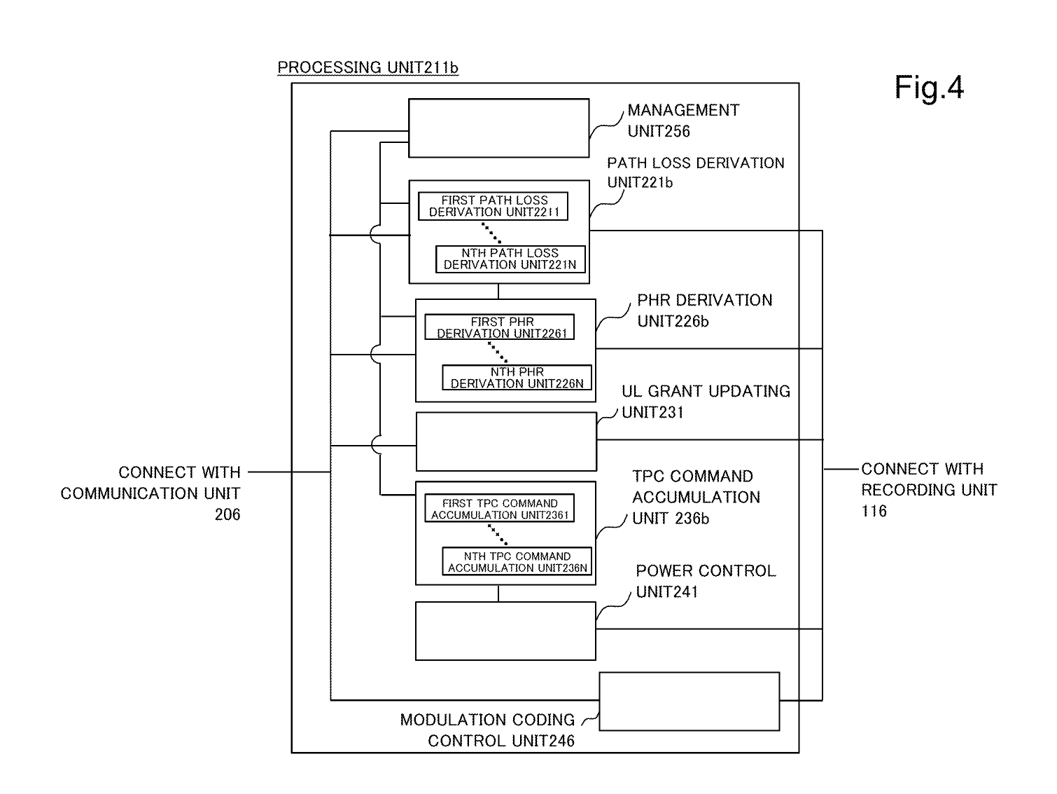

FIG. 4 is a conceptual diagram illustrating a configuration of a processing unit 211b which is an example of the processing unit 211a whose function unit is divided in the unit of the partial band.

The processing unit 211b includes a management unit 256, a path loss derivation unit 221b, a PHR derivation unit 226b, a UL grant updating unit 231, a TPC command accumulation unit 236b, a power control unit 241, and a modulation coding control unit 246.

When receiving the division information which is transmitted by the base station 101 illustrated in FIG. 1 to the mobile station 201 illustrated in FIG. 1, the management unit 256 generates the function unit which includes the path loss derivation unit 221b, the PHR derivation unit 226b, and the TPC command accumulation unit 236b. FIG. 4 illustrates the processing unit 211b in which the function unit has been generated.

The path loss derivation unit 221b includes N path loss derivation units of a first path loss derivation unit 2211 to a Nth path loss derivation unit 221N. A nth path loss derivation unit 221n (n is a positive integer equal to or smaller than N) is a part which derives the path loss of the nth partial band.

The PHR derivation unit 226b includes N path loss derivation units of a first PHR derivation unit 2261 to a Nth PHR derivation unit 226N. A nth PHR derivation unit 226n (n is a positive integer equal to or smaller than N) is a part which derives PHR on the nth partial band.

The TPC command accumulation unit 236b includes N path loss derivation units of a first TPC command accumulation unit 2361 to a Nth TPC command accumulation unit 236N. A nth TPC command accumulation unit 236n (n is a positive integer equal to or smaller than N) is a part which derives the TPC command accumulation value on the nth partial band.

The management unit 256 acquires a frequency, which the communication unit 206 actually uses for communication, from the communication unit 206. Then, the management unit 256 identifies the partial band to which the acquired frequency belongs. Afterward, the management unit 256 selects the path loss derivation unit 221n, the PHR derivation unit 226n, and the TPC command accumulation unit 236n which correspond to the identified frequency. The management unit 256 makes the path loss derivation unit 221n, the PHR derivation unit 226n, and the TPC command accumulation unit 236n, which are selected, carry out the above-mentioned processes which the path loss derivation unit 221, the PHR derivation unit 226, and the TPC command accumulation unit 236 carry out, respectively.

Explanation on processes which the UL grant updating unit 231, the power control unit 241, and the modulation coding control unit 246 in FIG. 4 carry out is the same as explanation on the processes which the UL grant updating unit 231, the power control unit 241, and the modulation coding control unit 246 in FIG. 3 carry out, respectively. However, in the explanation referring to FIG. 3, the path loss derivation unit 221, the PHR derivation unit 226, and the TPC command accumulation unit 236 are replaced with the path loss derivation unit 221b, the PHR derivation unit 226b, and the TPC command accumulation unit 236b, respectively.

[Example of Flow of Process]

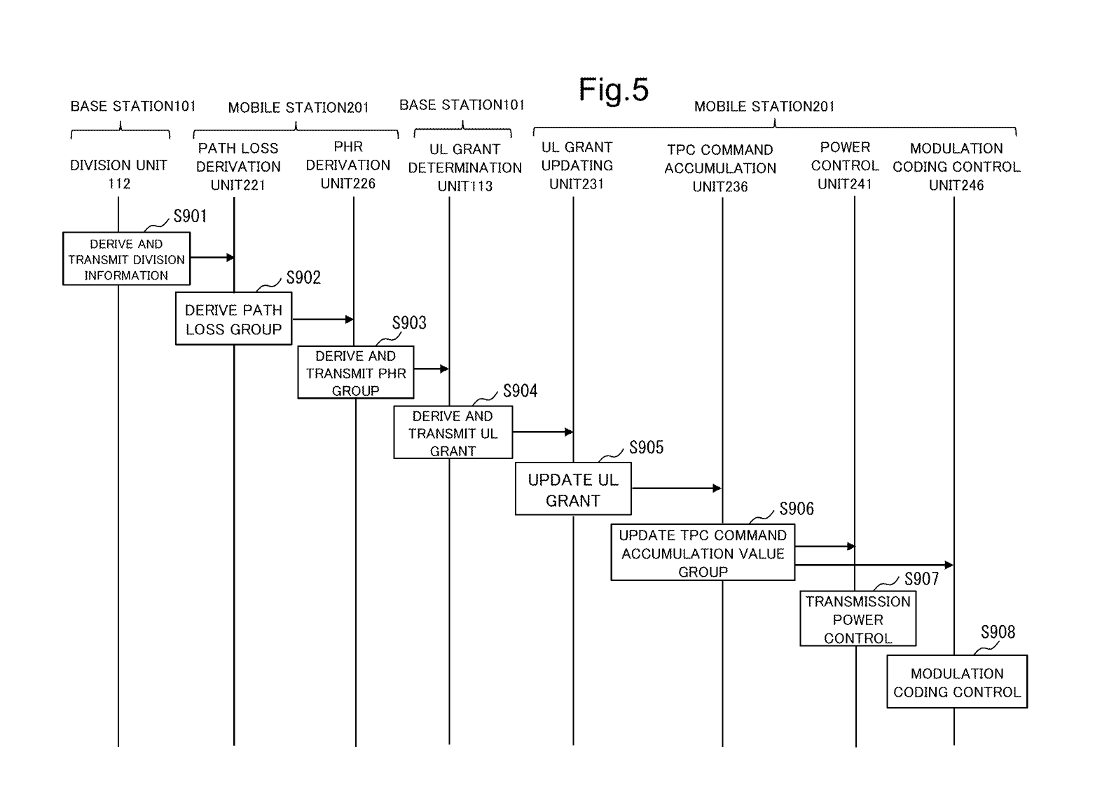

FIG. 5 is a sequence chart illustrating an example of processes which the processing unit 111a in FIG. 2, and the processing unit 211a in FIG. 3 carry out.

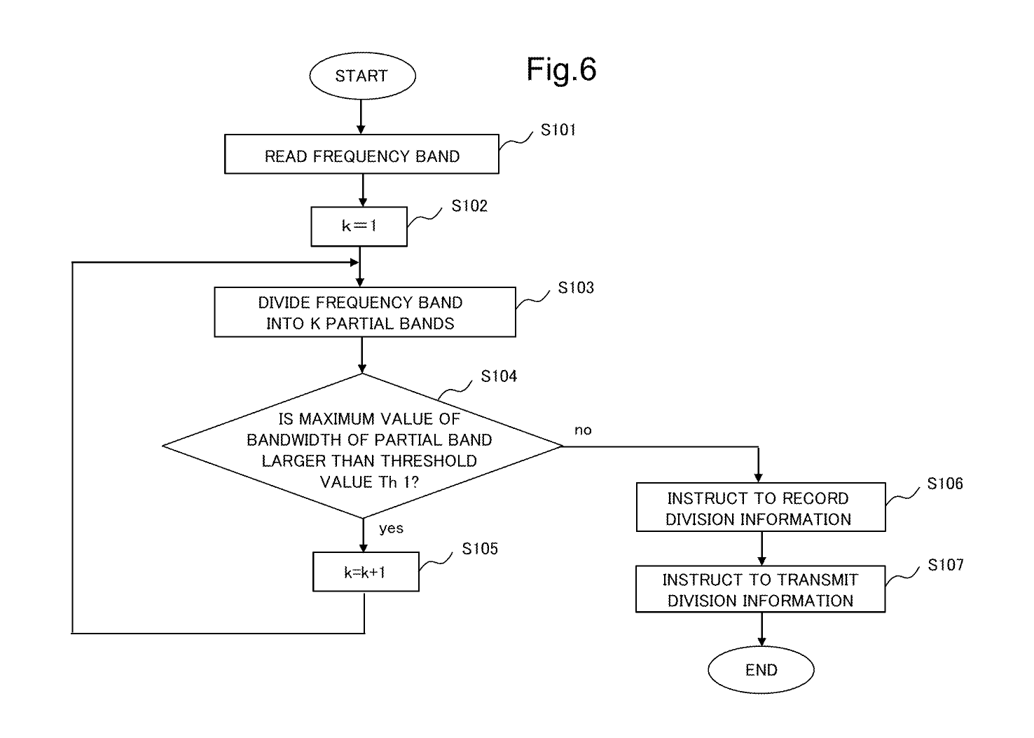

Firstly, as a process of S901, the division unit 112 of the base station 101 in FIG. 1 derives the division information, and transmits the derived division information to the mobile station 201. An example of the process of S901 will be mentioned later with reference to FIG. 6.

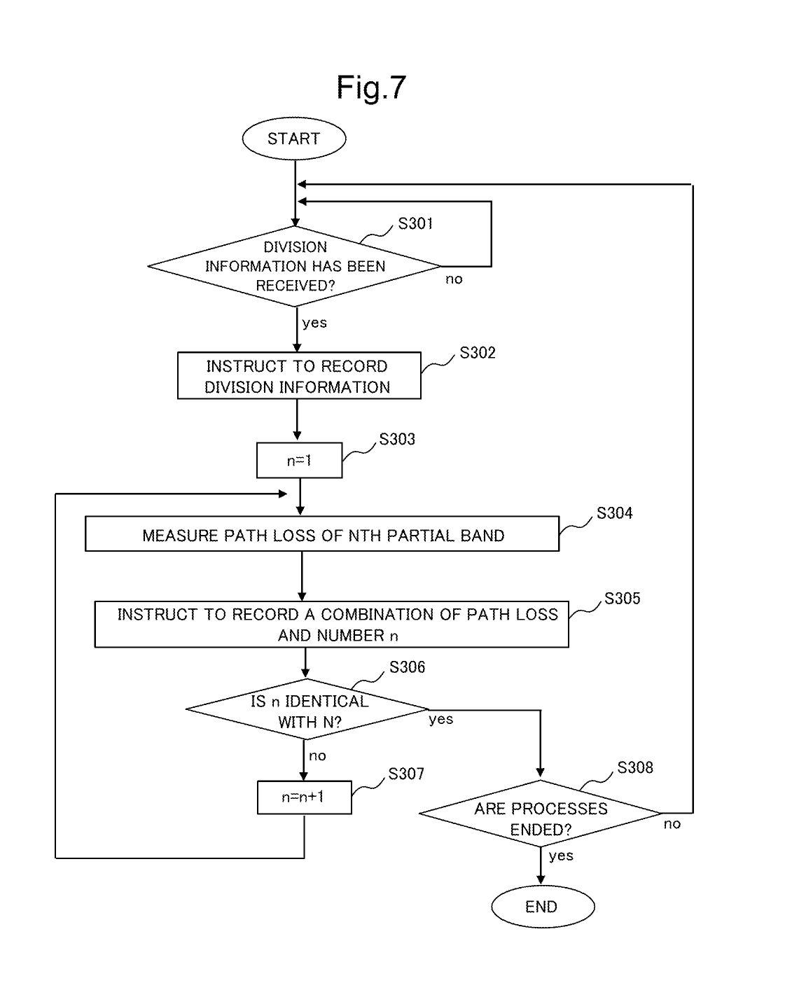

Next, as a process of S902, the path loss derivation unit 221 of the mobile station 201 derives a path loss group which is a group of the path losses of the partial bands. Here, the path loss of the partial band is indicated by the division information transmitted by the division unit 112. An example of the process of S902 will be mentioned later with reference to FIG. 7.

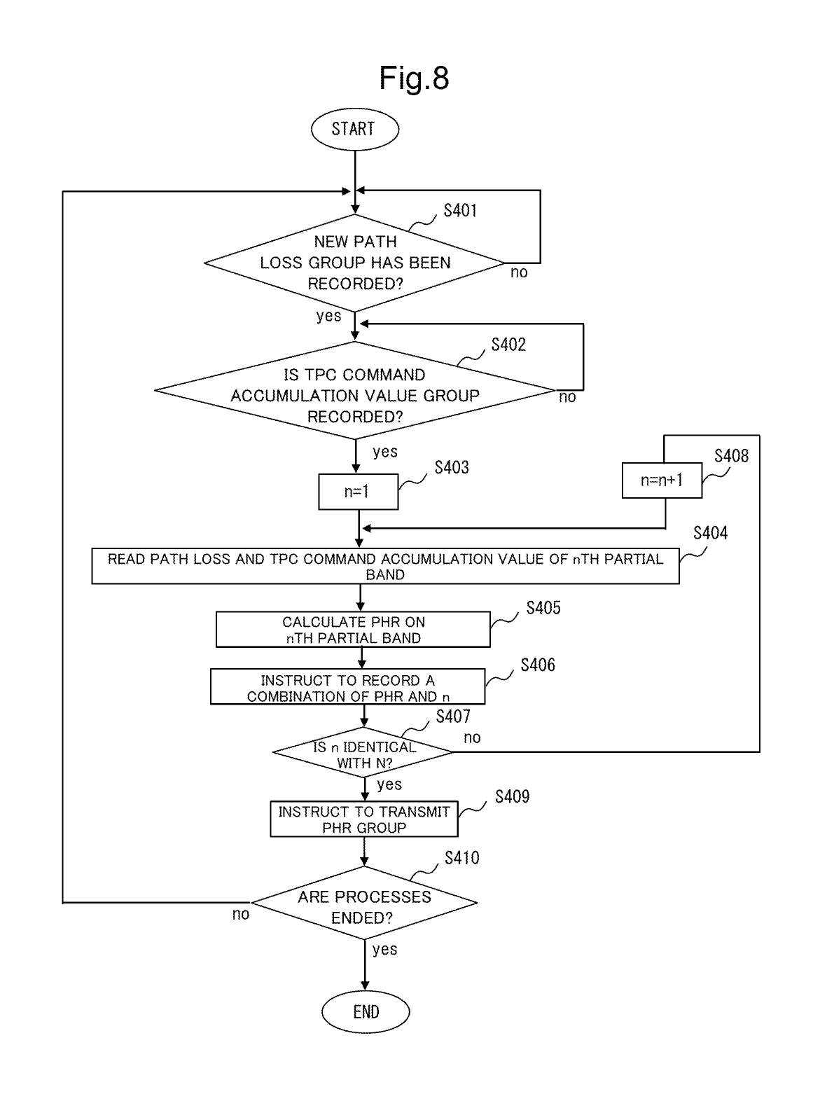

Next, as a process of S903, the PHR derivation unit 226 of the mobile station 201 derives a PHR group, which is a group of PHRs on the partial bands, from the path loss group which is derived by the path loss derivation unit 221, and transmits the PHR group to the base station 101. An example of the process of S903 will be mentioned later with reference to FIG. 8.

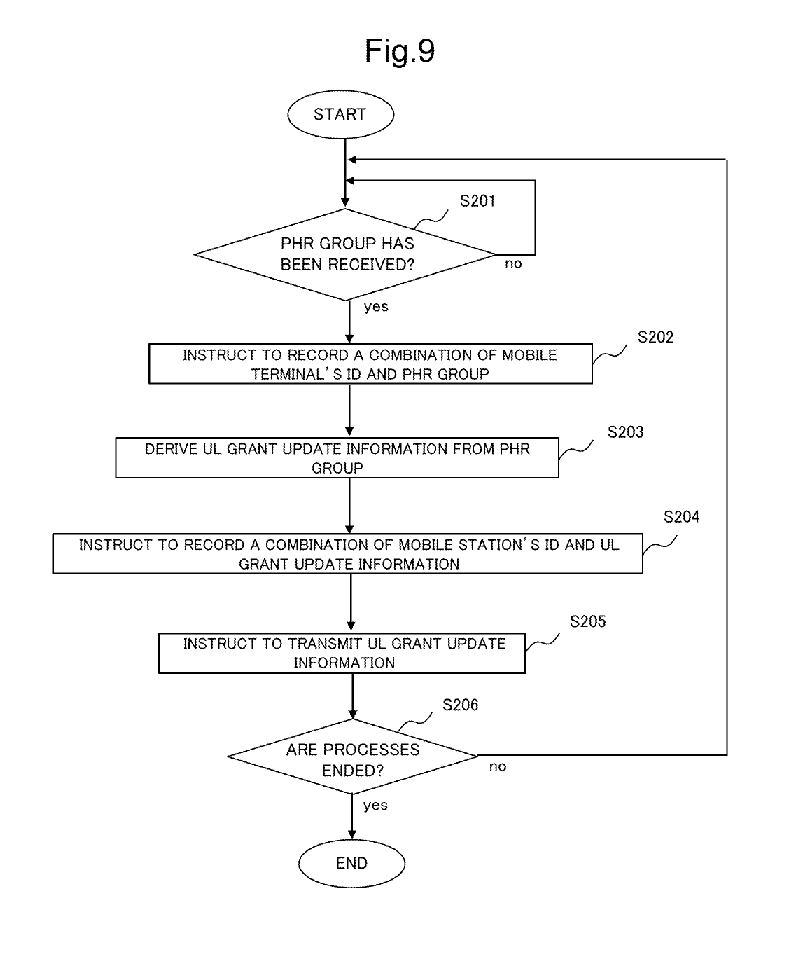

Next, as a process of S904, the UL grant determination unit 113 of the base station 101 derives the UL grant from the PHR group which is transmitted by the PHR derivation unit 226, and transmits the derived UL grant to the mobile station 201. An example of the process of S904 will be mentioned later with reference to FIG. 9.

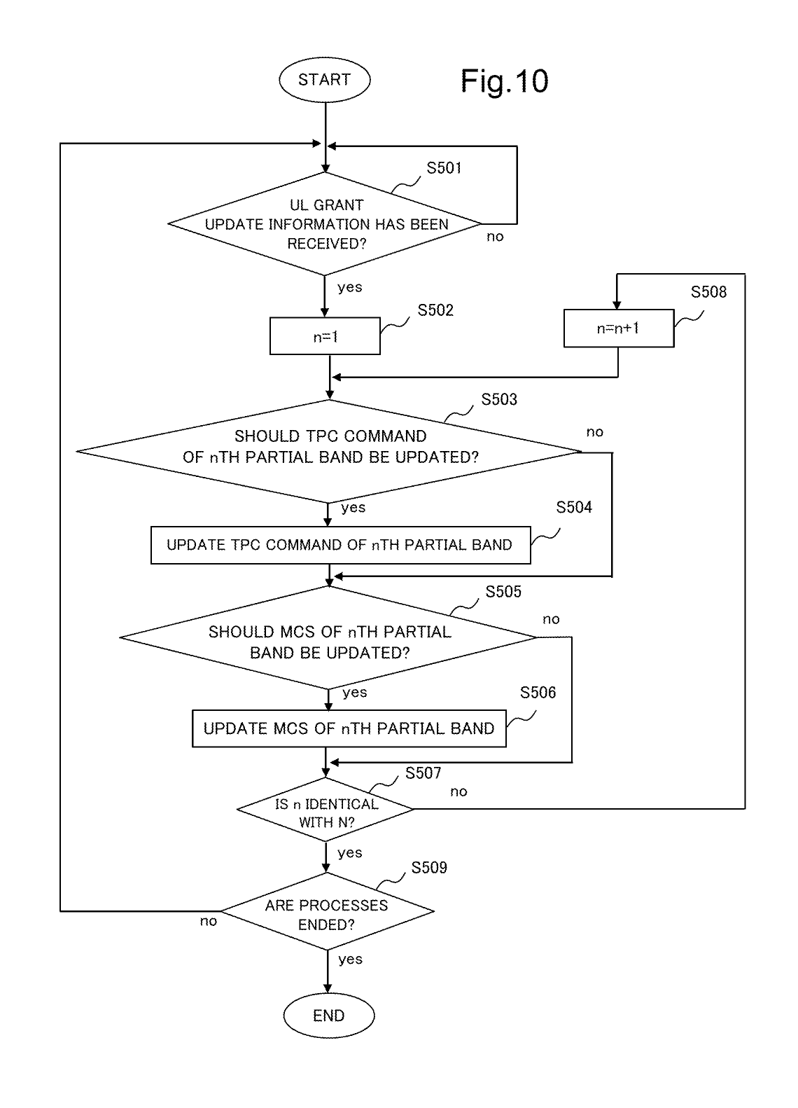

Next, as a process of S905, the UL grant updating unit 231 updates a part or a whole of the UL grant, which is held as a just previous value by the recording unit 216 illustrated in FIG. 1, based on UL grant update information which is transmitted by the UL grant determination unit 113. An example of the process of S905 will be mentioned later with reference to FIG. 10.

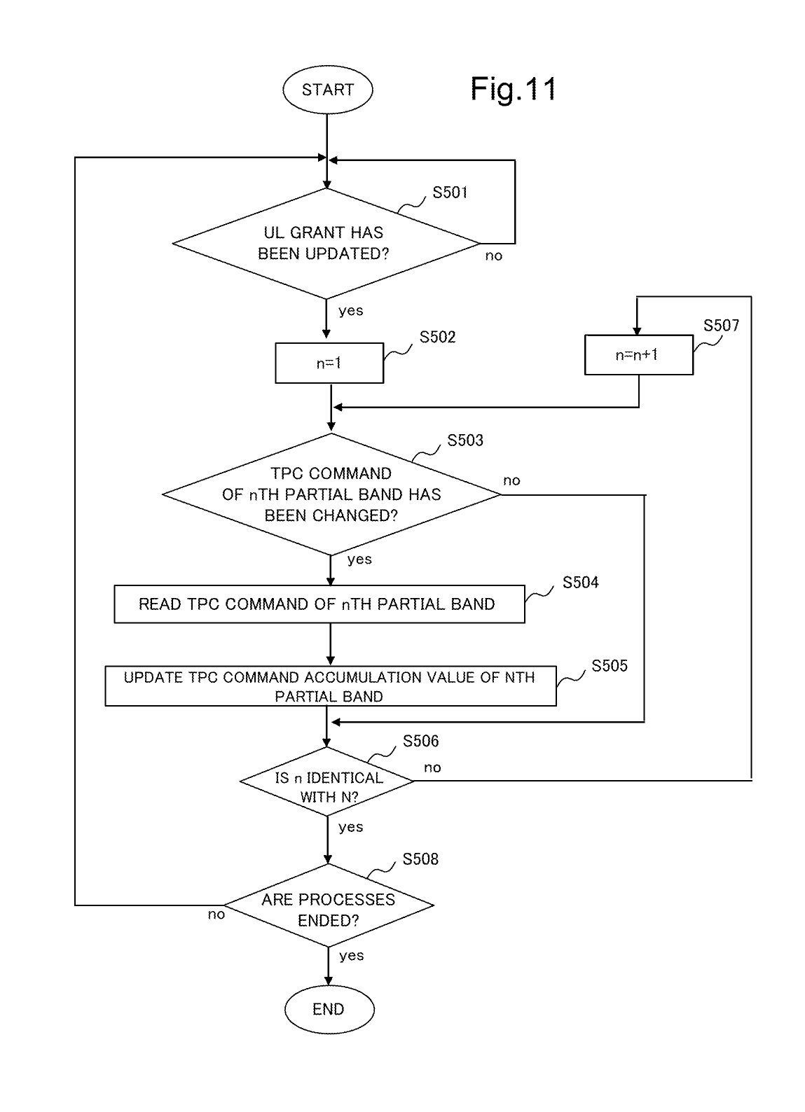

Next, as a process of S906, the TPC command accumulation unit 236 updates the TPC command accumulation value if necessary. An example of the process of S906 will be mentioned later with reference to FIG. 11.

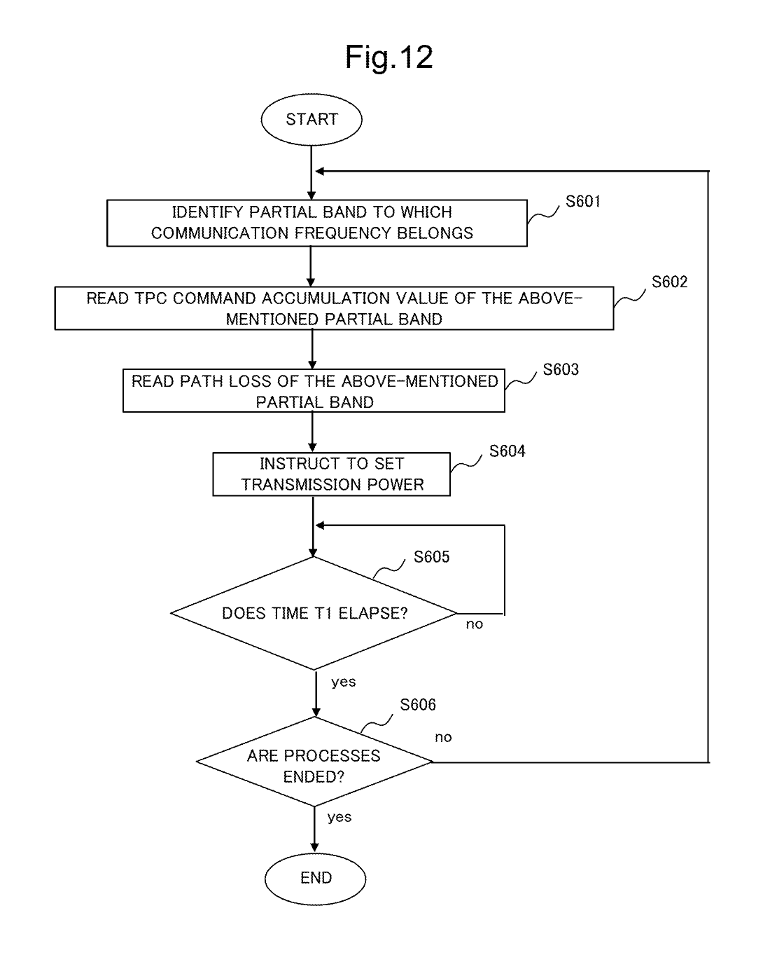

Next, as a process of S907, the power control unit 241 carries out the transmission power control, which relates to transmission carried out by the communication unit 206 illustrated in FIG. 1, based on a TPC command accumulation value group. An example of the process of S907 will be mentioned later with reference to FIG. 12.

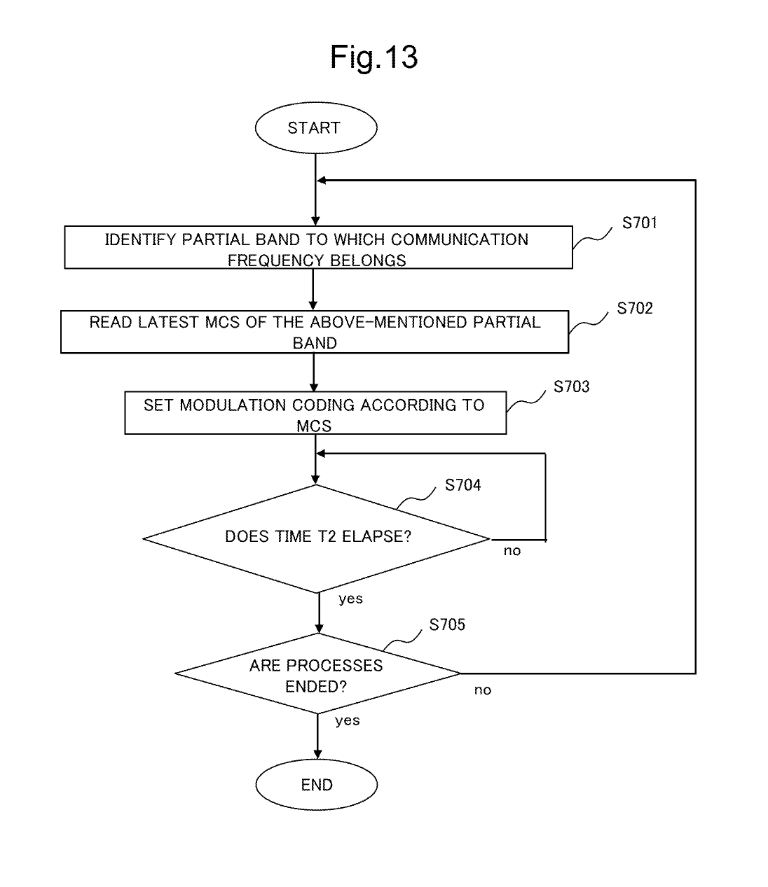

Moreover, as a process of S908 the modulation coding control unit 246 carries out the modulation coding control, which relates to transmission carried out by the communication unit 206 illustrated in FIG. 1, based on the TPC command accumulation value group. An example of the process of S908 will be mentioned later with reference to FIG. 13.

FIG. 6 is a conceptual diagram illustrating an example of a flow of the process of S901 in FIG. 5 which is carried out by the division unit 112 in FIG. 2.

The division unit 112 starts the process illustrated in FIG. 6, for example, by inputting start information from the outside.

Then, as a process of S101, the division unit 112 reads the frequency band, which is assigned to communication of the base station 101 with the mobile station 201, from the recording unit 116. Here, the base station 101 and the mobile station 201 are illustrated in FIG. 1. Here, it is assumed that the recording unit 116 holds the frequency band in advance.

Next, as a process of S102, the division unit 112 substitutes 1 for an integer k which is number of the partial bands into which the frequency band is divided.

Then, as a process of S103, the division unit 112 divides the frequency band into k partial bands. Here, when the integer k is 1, the partial band is just identical with the frequency band. When the integer k is larger than 1 (when carrying out the process of S103 after carrying out a process of S105), the division unit 112 sets each partial band, which has been generated by the division, for example, so as to have almost equal bandwidth after the division.

Next, as a process of S104, the division unit 112 determines whether a maximum value of the bandwidth of each partial band is larger than a threshold value Th 1. Here, the threshold value Th 1 is a threshold value of the bandwidth which is predetermined for the process of S104. The threshold level Th 1 is held, for example, by the recording unit 116 in advance.

When a determination result in the process of S104 is yes, the division unit 112 carries out a process of S105.

On the other hand, when the determination result in the process of S104 is no, the division unit 112 carries out a process of S106.

When carrying out the process of S105, the division unit 112 increases a value of the integer k by 1 as the process of S105. Then, the division unit 112 carries out the process of S103 again.

When carrying out the process of S106, the division unit 112 instructs the recording unit 116 to record the above-mentioned division information as the process of S106. Here, the division information is, for example, information which indicates a minimum frequency and a maximum frequency of each partial band.

Then, as a process of S107, the division unit 112 makes the communication unit 106 in FIG. 1 transmit the division information toward the mobile station 201 through the wireless circuit.

By carrying out the above-mentioned processes, the division unit 112 ends the processes illustrated in FIG. 6.

FIG. 7 is a conceptual diagram illustrating an example of a flow of the process of S902 which the path loss derivation unit 221 of the mobile station 201 carries out. Here, the mobile station 201, the path loss derivation unit 221, and S902 are illustrated in FIG. 1, FIG. 3, and FIG. 5, respectively.

The path loss derivation unit 221 starts the process illustrated in FIG. 7 by inputting start information from the outside.

Then, as a process of S301, the path loss derivation unit 221 determines whether receiving the above-mentioned division information from the base station 101, which is illustrated in FIG. 1, through the communication unit 206.

When a determination result in the process of S301 is yes, the path loss derivation unit 221 carries out a process of S302.

On the other hand, when the determination result in the process of S301 is no, the path loss derivation unit 221 carries out the process of S301 again.

When carrying out the process of S302, the path loss derivation unit 221 instructs the recording unit 216, which is illustrated in FIG. 1, to record the division information as the process of S302.

Then, as a process of S303, the path loss derivation unit 221 substitutes 1 for an integer n. Here, the integer n is a number which is assigned to the partial band.

Next, as a process of S304, the path loss derivation unit 221 derives the path loss of the nth partial band. Here, a method for deriving the path loss is described by the NPL 2.

Then, as a process of S305, the path loss derivation unit 221 makes the recording unit 216 record information which indicates a combination of the path loss derived in the process of S304, and the integer n.

Next, as a process of S306, the path loss derivation unit 221 determines whether the integer n is identical with an integer N. Here, the integer N is number of the partial bands (division number) which is indicated by the division information.

When a determination result in the process of S306 is no, the path loss derivation unit 221 carries out a process of S307.

On the other hand, when the determination result in the process of S306 is yes, the path loss derivation unit 221 carries out a process of S308.

When carrying out the process of S307, the path loss derivation unit 221 increases the integer n by 1 as the process of S307. Then, the path loss derivation unit 221 carries out the process of S304 again.

When carrying out the process of S308, the path loss derivation unit 221 determines whether to end the processes, which are illustrated in FIG. 7, as the process of S308. The path loss derivation unit 221 carries out the above-mentioned determination, for example, by determining whether ending information from the outside is inputted or not.

When a determination result in the process of S308 is yes, the path loss derivation unit 221 ends the processes which are illustrated in FIG. 7.

On the other hand, when the determination result in the process of S308 is no, the path loss derivation unit 221 carries out the process of S301 again.

FIG. 8 is a conceptual diagram illustrating an example of a flow of the process of S903 which is carried out by the PHR derivation unit 226 of the mobile station 201. Here, the mobile station 201, the PHR derivation unit 226, and S903 are illustrated in FIG. 1, FIG. 3, and FIG. 5, respectively.

The PHR derivation unit 226 starts the processes, which are illustrated in FIG. 8, for example, by inputting start information from the outside.

Then, as a process of S401, the PHR derivation unit 226 determines whether the new path loss group is recorded by the recording unit 216, which is illustrated in FIG. 1, according to an instruction of the path loss derivation unit 221. Here, it is assumed that, after starting the processes illustrated in FIG. 8, the PHR derivation unit 226 monitors whether the new path loss group is recorded by the recording unit 216, which is illustrated in FIG. 1, according to the instruction of the path loss derivation unit 221.

When a determination result in the process of S401 is yes, the PHR derivation unit 226 carries out a process of S402.

On the other hand, when the determination result in the process of S401 is no, the PHR derivation unit 226 carries out the process of S401 again.

When carrying out the process of S402, the PHR derivation unit 226 determines whether the TPC command accumulation value group is recorded by the recording unit 216 as the process of S402. Here, the TPC command accumulation value group is a group of the TPC command accumulation value on each partial band which the above-mentioned division information indicates. The TPC command accumulation value group is set or updated in a process of S506 which will be mentioned later with reference to FIG. 11.

When a determination result in the process of S402 is yes, the PHR derivation unit 226 carries out a process of S403.

On the other hand, when the determination result in the process of S402 is no, the PHR derivation unit 226 carries out the process of S402 again.

When carrying out the process of S403, the PHR derivation unit 226 substitutes 1 for an integer n as the process of S403. As mentioned above, the integer n is a numerical value indicating number of the partial bands which are expressed in the division information.

Then, as a process of S404, the PHR derivation unit 226 reads the path loss of the nth partial band, which is included in the path loss group, from the recording unit 216. Moreover, as the process of S404, the PHR derivation unit 226 reads the TPC command accumulation value on the nth partial band, which is included in the TPC command accumulation value group, from the recording unit 216.

Then, as a process of S405, the PHR derivation unit 226 derives PHR from the path loss and the TPC command accumulation value on the nth partial band which are read in the process of S404. Formulas, which are used for deriving PHR are the formula 1 and the formula 2 which are explained in a clause of Background Art.

Next, as a process of S406, the PHR derivation unit 226 instructs the recording unit 216 to record information which indicates a combination of PHR on the nth partial band derived in the process of S405, and the integer n.

Then, as a process of S407, the PHR derivation unit 226 determines whether the integer n is identical with the integer N. Here, as mentioned above, the integer N is the number of the partial bands (division number) which is indicated by the division information.

When a determination result in the process of S407 is no, the PHR derivation unit 226 carries out a process of S408.

On the other hand, when the determination result in the process of S407 is yes, the PHR derivation unit 226 carries out a process of S409.

When carrying out the process of S408, the PHR derivation unit 226 increases a value of the integer n by 1 as the process of S408. Then, the PHR derivation unit 226 carries out the process of S404 again.

When carrying out the process of S409, the PHR derivation unit 226 makes the communication unit 206, which is illustrated in FIG. 1, transmit the PHR group, which is the group of PHR on each partial band indicated by the division information, to the base station 101 as the process of S409.

Then, as a process of S410, the PHR derivation unit 226 determines whether to end the processes which are illustrated in FIG. 8. The PHR derivation unit 226 carries out the above-mentioned determination, for example, by determining whether ending information is inputted from the outside or not.

When a determination result in the process of S410 is yes, the PHR derivation unit 226 ends the processes which are illustrated in FIG. 8.

On the other hand, when the determination result in the process of S410 is no, the PHR derivation unit 226 carries out the process of S401 again.

FIG. 9 is a conceptual diagram illustrating an example of a flow of the process of S904 which the UL grant determination unit 113 of the base station 101 carries out. Here, the base station 101, the UL grant determination unit 113, and S904 are illustrated in FIG. 1, FIG. 2, and FIG. 5, respectively.

Firstly, the UL grant determination unit 113 starts the processes which are illustrated in FIG. 9, for example, by inputting start information from the outside.

Next, the UL grant determination unit 113 determines whether the PHR group, which is transmitted by the mobile station 201, is received through the communication unit 106 illustrated in FIG. 1.

When a determination result in the process of S201 is yes, the UL grant determination unit 113 carries out a process of S202.

On the other hand, when the determination result in the process of S201 is no, the UL grant determination unit 113 carries out the process of S201 again.

When carrying out the process of S202, the UL grant determination unit 113 makes the recording unit 116, which is illustrated in FIG. 1, record a combination of the PHR group which is determined to be received in the process of S201, and ID of the mobile station which transmits the PHR group, as the process of S202.

Next, as a process of S203, the UL grant determination unit 113 derives the UL grant update information from the PHR group which is recorded in the process of S202. Here, the UL grant update information is information to make the mobile station 201 update the UL grant which is held by the mobile station 201 illustrated in FIG. 1. However, at a stage when the mobile station 201 does not hold the UL grant, the UL grant update information is just identical with the UL grant.

The UL grant update information includes, for example, information which indicates whether the mobile station 201 can update the sub UL grant which is corresponding to each partial band or not. In this case, the information indicating possibility of the update is expressed as a bit indicating the possibility of the update. In this case, existence of the bit may mean to carry out the update. Alternatively, existence of the bit may mean not to carry out the update.

When the sub UL grant of the predetermined partial band is updated, the UL grant update information further includes information indicating the new sub UL grant with which the current sub UL grant should be replaced.

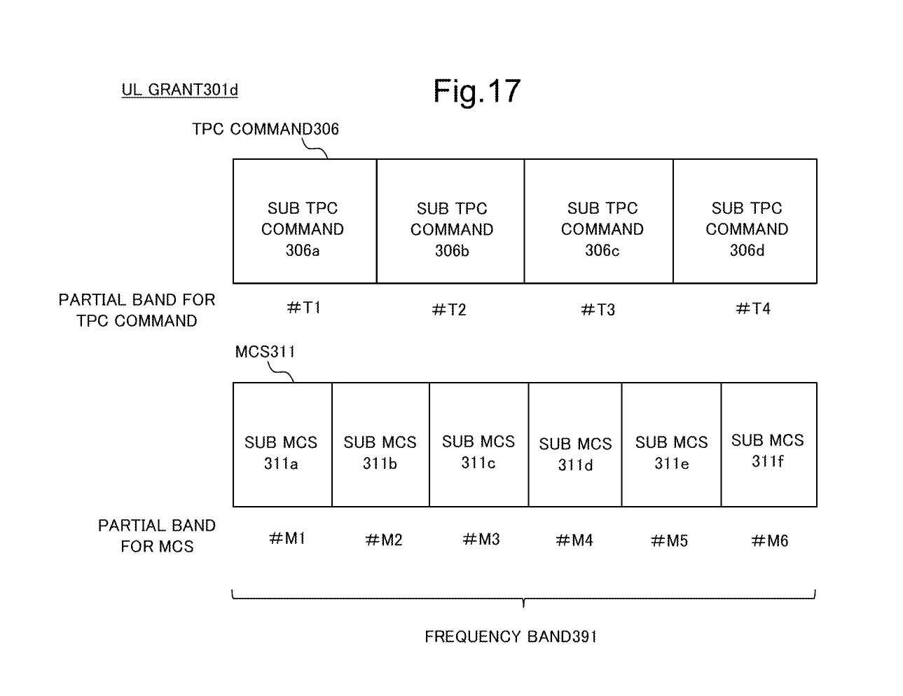

The UL grant update information may include information which indicates whether the mobile station 201 can update each of the sub TPC command and the sub MCS, which are included in the sub UL grant, for each partial band. Moreover, the partial band whose sub TPC command should be updated by the mobile station 201, and the partial band whose sub MCS should be updated by the mobile station 201 may be different from each other. The above will be mentioned later with reference to FIG. 17.

When the UL grant update information includes the information which indicates whether the mobile station 201 can update each of the sub TPC command and the sub MCS for each partial band, the UL grant update information includes information on the sub TPC command, and the sub MCS which should be updated.

The UL grant update information may have contents which make the mobile station 201 update all of the UL grants of the partial bands which are held by the mobile station 201.

Next, as a process of S204, the UL grant determination unit 113 makes the recording unit 116, which is illustrated in FIG. 1, record the UL grant update information which is derived in the process of S203.

Then, as a process of S205, the UL grant determination unit 113 makes the communication unit 106, which is illustrated in FIG. 1, transmit the UL grant update information, which is recorded in the process of S204, toward the mobile station 201.

Next, as a process of S206, the UL grant determination unit 113 determines whether to end the processes which are illustrated in FIG. 9. The UL grant determination unit 113 carries out the above-mentioned determination, for example, by determining whether ending information is inputted from the outside or not.

When a determination result in the process of S206 is yes, the UL grant determination unit 113 ends the processes which are illustrated in FIG. 9.

On the other hand, when the determination result in the process of S206 is no, the UL grant determination unit 113 carries out the process of S201 again.

FIG. 10 is a conceptual diagram illustrating an example of a flow of the process of S905 which the UL grant updating unit 231 of the base station 201 carries out. Here, the base station 201, the UL grant updating unit 231, and S905 are illustrated in FIG. 1, FIG. 3, and FIG. 5, respectively.

Firstly, the UL grant updating unit 231 starts the processes which are illustrated in FIG. 10, for example, by receiving start information from the outside.

Next, as a process of S501, the UL grant updating unit 231 determines whether the new UL grant update information is received, which is transmitted by the mobile station 101, through the communication unit 206 illustrated in FIG. 1.

When a determination result in the process of S501 is yes, the UL grant updating unit 231 carries out a process of S502.

On the other hand, when the determination result in the process of S501 is no, the UL grant updating unit 231 carries out the process of S501 again.

When carrying out the process of S502, the UL grant updating unit 231 substitutes 1 for an integer n as the process of S502. Here, the integer n is a number which is assigned to each partial band.

Then, as a process of S503, the UL grant updating unit 231 determines whether the UL grant update information, which is determined to be received in the process of S501, indicates that the TPC command of the nth partial band should be updated.

When a determination result in the process of S503 is yes, the UL grant updating unit 231 carries out a process of S504.

On the other hand, when the determination result in the process of S503 is no, the UL grant updating unit 231 carries out a process of S505.

When carrying out the process of S504, the UL grant updating unit 231 updates the TPC command of the nth partial band, which is held by the recording unit 216 illustrated in FIG. 1, as the process of S504. The UL grant updating unit 231 carries out the update based on information that the nth TPC command should be replaced according to the UL grant update information. Then, the UL grant updating unit 231 carries out the process of S505.

When carrying out the process of S505, the UL grant updating unit 231 determines whether the UL grant update information, which is determined to be received in the process of S501, indicates that MCS of the nth partial band should be updated, as the process of S505.

When a determination result in the process of S505 is yes, the UL grant updating unit 231 carries out a process of S506.

On the other hand, when the determination result in the process of S505 is no, the UL grant updating unit 231 carries out a process of S507.

When carrying out the process of S506, the UL grant updating unit 231 updates MCS of the nth partial band, which is held by the recording unit 216 illustrated in FIG. 1, as the process of S506. The UL grant updating unit 231 carries out the update based on information that the nth MCS should be replaced according to the UL grant update information. Then, the UL grant updating unit 231 carries out the process of S507.

When carrying out the process of S507, the UL grant updating unit 231 determines whether a value of the integer n is identical with the integer N, as the process of S507. Here, as mentioned above, the integer N is number of the partial bands (division number) which is indicated by the division information.

When a determination result in the process of S507 is yes, the UL grant updating unit 231 carries out a process of S509.

On the other hand, when the determination result in the process of S507 is no, the UL grant updating unit 231 carries out a process of S508.

When carrying out the process of S508, the UL grant updating unit 231 increases the value of integer n by 1 as the process of S508.

Then, the UL grant updating unit 231 carries out the process of S503 again.

When carrying out the process of S509, the UL grant updating unit 231 determines whether to end the processes which are illustrated in FIG. 10. The UL grant updating unit 231 carries out the above-mentioned determination, for example, by determining whether ending information is inputted from the outside or not.

When a determination result in the process of S509 is yes, the UL grant updating unit 231 ends the processes which are illustrated in FIG. 10.

On the other hand, when the determination result in the process of S509 is no, the UL grant updating unit 231 carries out the process of S501 again.

FIG. 11 is a conceptual diagram illustrating an example of a flow of the process of S906 which the TPC command accumulation unit 236 of the base station 201 carries out. Here, the base station 201, the TPC command accumulation unit 236, and S906 are illustrated in FIG. 1, FIG. 3, and FIG. 5, respectively.

Firstly, the TPC command accumulation unit 236 starts the processes which are illustrated in FIG. 11, for example, by inputting start information from the outside.

Next, as a process of S501, the TPC command accumulation unit 236 determines whether the UL grant, which is held by the recording unit 216 illustrated in FIG. 1, has been updated (the process of S905 illustrated in FIG. 5). Here, it is assumed that, after starting the processes which are illustrated in FIG. 11, the TPC command accumulation unit 236 monitors whether the UL grant has been updated (the process of S905 illustrated in FIG. 5).

When a determination result in the process of S501 is yes, the TPC command accumulation unit 236 carries out a process of S502.

On the other hand, when the determination result in the process of S501 is no, the TPC command accumulation unit 236 carries out the process of S501 again.

When carrying out the process of S502, the TPC command accumulation unit 236 substitutes 1 for an integer n as the process of S502. Here, the integer n is the number which is assigned to each partial band.

Then, as a process of S503, the TPC command accumulation unit 236 determines whether the TPC command of the nth partial band is changed (updated).

When a determination result in the process of S503 is yes, the TPC command accumulation unit 236 carries out a process of S504.

On the other hand, when the determination result in the process of S503 is no, the TPC command accumulation unit 236 carries out a process of S506.

When carrying out the process of S504, the TPC command accumulation unit 236 reads the updated TPC command of the nth partial band from the recording unit 216, which is illustrated in FIG. 1, as the process of S504.

Then, as a process of S505, the TPC command accumulation unit 236 updates the TPC command accumulation value of the nth partial band which is held by recording unit 216. The TPC command accumulation unit 236 carries out the update by replacing the old TPC command accumulation value, which the recording unit 216 holds currently, with the new TPC command accumulation value which is obtained by adding the new TPC command to the old TPC command accumulation value.

Next, as the process of S506, the TPC command accumulation unit 236 determines whether a value of the integer n is identical with the integer N. Here, the integer N is the number of the partial bands (division number) which is indicated by the division information.

When a determination result in the process of S506 is yes, the TPC command accumulation unit 236 carries out a process of S508.

On the other hand, when the determination result in the process of S506 is no, the TPC command accumulation unit 236 carries out a process of S507.

When carrying out the process of S507, the TPC command accumulation unit 236 increases the value of the integer n by 1 as the process of S507. Then, the TPC command accumulation unit 236 carries out the process of S503 again.

When carrying out the process of S508, the TPC command accumulation unit 236 determines whether to end the processes which are illustrated in FIG. 11, as the process of S508. The TPC command accumulation unit 236 carries out the above-mentioned determination, for example, by determining whether ending information is inputted from the outside or not.

When a determination result in the process of S508 is yes, the TPC command accumulation unit 236 ends the processes which are illustrated in FIG. 11.

On the other hand, when the determination result in the process of S508 is no, the TPC command accumulation unit 236 carries out the process of S501 again.

FIG. 12 is a conceptual diagram illustrating an example of a flow of S907 which the power control unit 241 of the mobile station 201 carries out. Here, the mobile station 201, the power control unit 241, and S907 are illustrated in FIG. 1, FIG. 3, and FIG. 5, respectively.

The power control unit 241 starts the processes, which are illustrated in FIG. 12, for example, by inputting start information from the outside.

Next, as a process of S601, the power control unit 241 identifies the partial band to which a frequency used for communication of the communication unit 206 illustrated in FIG. 1 with the base station 101 at this point of time belongs. Here, it is assumed that, after start of the processes which are illustrated in FIG. 12, the power control unit 241 monitors the frequency which is used for communication of the communication unit 206 with the base station 101.

Then, as a process of S602, the power control unit 241 reads the TPC command accumulation value on the partial band, which is identified in the process of S601, from the recording unit 216 illustrated in FIG. 1. Typically, the TPC command accumulation value is a latest value which is updated in the processes illustrated in FIG. 11.

Then, as a process of S603, the power control unit 241 reads the derived path loss on the partial band which is identified in the process of S601. The path loss is recorded in the recording unit 216 by carrying out the process of S305 which is illustrated in FIG. 7.

Then, as a process of S604, the power control unit 241 makes the communication unit 206, which is illustrated in FIG. 1, set the transmission power based on the TPC command accumulation value which is read in the process of S602, and the path loss which is read in the process of S603. A method of controlling the transmission power based on the TPC command accumulation value and the path loss is described by the NPL 2.

Then, as a process of S605, the power control unit 241 determines whether a time T1 elapses. Here, the time T1 is a time which indicates an interval for carrying out the consecutive processes of S601 to S604, and is set beforehand. The time T1 is held, for example, by the recording unit 216.

When a determination result in the process of S605 is yes, the power control unit 241 carries out a process of S606.

On the other hand, when the determination result in the process of S605 is no, the power control unit 241 carries out the process of S605 again.

When carrying out the process of S606, the power control unit 241 determines whether to end the processes, which are illustrated in FIG. 12, as the process of S606. The power control unit 241 carries out the determination, for example, by determining whether ending information is inputted from the outside or not.

When a determination result in the process of S606 is yes, the power control unit 241 ends the processes which are illustrated in FIG. 12.

On the other hand, when the determination result in the process of S606 is no, the power control unit 241 carries out the process of S601 again.

FIG. 13 is a conceptual diagram illustrating an example of a flow of S908 which the modulation coding control unit 246 of the mobile station 201 carries out. Here, the mobile station 201, the modulation coding control unit 246, and S908 are illustrated in FIG. 1, FIG. 3, and FIG. 5, respectively.

The modulation coding control unit 246 starts the processes, which are illustrated in FIG. 13, for example, by receiving start information from the outside.

Next, as a process of S701, the modulation coding control unit 246 identifies the partial band to which a frequency used for communication of the communication unit 206 illustrated in FIG. 1 with the base station 101 at this point of time belongs. Here, it is assumed that, after start of the processes which are illustrated in FIG. 13, the modulation coding control unit 246 monitors the frequency which is used for communication of the communication unit 206 with the base station 101.

Then, as a process of S702, the modulation coding control unit 246 reads MCS on the partial band, which is identified in the process of S701, from the recording unit 216 illustrated in FIG. 1. Typically, the above-mentioned MCS is a latest MCS which is updated in the processes illustrated in FIG. 10.

Then, as a process of S703, the modulation coding control unit 246 makes the communication unit 206, which is illustrated in FIG. 1, carry out to set the modulation coding based on MCS which is read in the process of S702. A method of setting the modulation coding is described by the NPL 2.

Then, as a process of S704, the modulation coding control unit 246 determines whether a time T2 elapses. Here, the time T2 is a time which indicates an interval for carrying out the consecutive processes of S701 to S703, and is set beforehand. The time T2 is held, for example, by the recording unit 216.

When a determination result in the process S704 is yes, the modulation coding control unit 246 carries out a process of S705.

On the other hand, when the determination result in the process S704 is no, the modulation coding control unit 246 carries out the process of S704 again.

When carrying out the process of S705, the modulation coding control unit 246 determines whether to end the processes, which are illustrated in FIG. 13, as the process of S705. The modulation coding control unit 246 carries out the determination, for example, by determining whether ending information is inputted from the outside or not.

When a determination result in the process of S705 is yes, the modulation coding control unit 246 ends the processes which are illustrated in FIG. 13.

On the other hand, when the determination result in the process of S705 is no, the modulation coding control unit 246 carries out the process of S701 again.

[Example of Setting UL Grant]

Next, an example of the UL grant, which is updated by the UL grant updating unit 231 of the mobile station 201. Here, the mobile station 201 and the UL grant updating unit 231 are illustrated in FIG. 1 and FIG. 3, respectively.

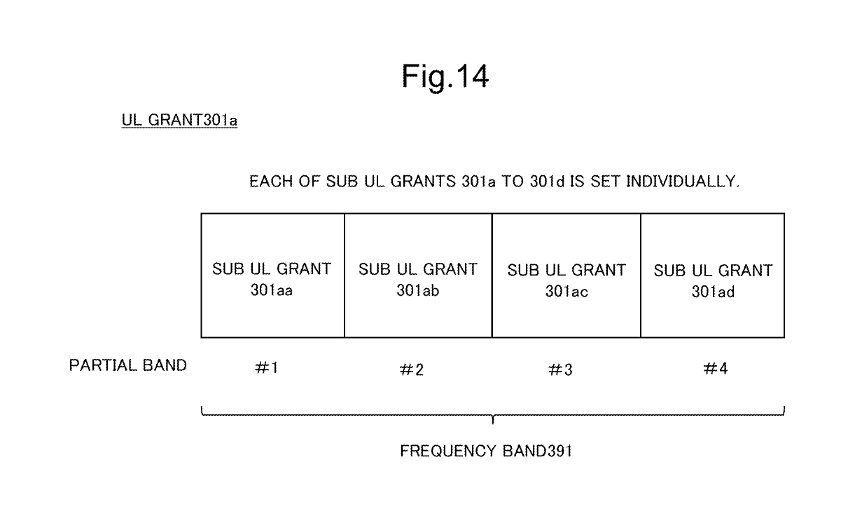

FIG. 14 is an image diagram illustrating a UL grant 301a which is an example of the UL grant whose sub grants are set and updated differently for each partial band.

A frequency band 391 is divided into four partial bands #1 to #4.

The UL grant 301a includes sub UL grants 301aa to 301ad.

The sub UL grants 301aa to 301ad are corresponding to partial bands #1 to #4, respectively. Moreover, the sub UL grants 301aa to 301ad are set and updated individually by the UL grant updating unit 231.

In order to individually set and update the sub UL grants 301aa to 301ad, the UL grant determination unit 113, which is illustrated in FIG. 2, prescribes to update each of UL grants 301a to 301d in the above-mentioned UL grant update information. Moreover, the UL grant determination unit 113 makes each of the updated UL grants 301a to 301d embedded in the above-mentioned UL grant update information.

The sub UL grant on each partial band can be set and updated freely in the UL grant 301a.

FIG. 14 illustrates an example that the frequency band 391 is divided into four partial bands #1 to #4, but the division number of the frequency band is optional.

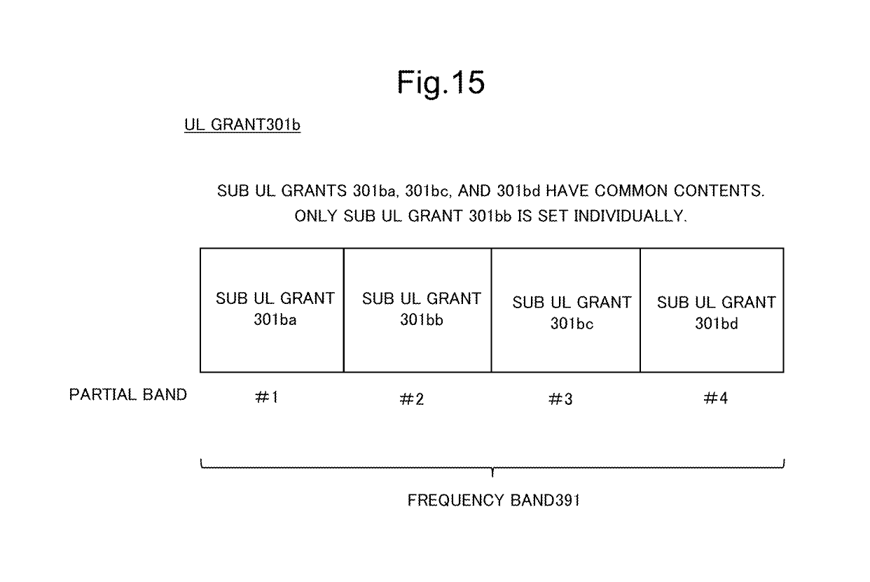

FIG. 15 is an image diagram illustrating the UL grant 301b which is an example of the UL grant in which the sub UL grant common to the plural partial bands is set.

The frequency band 391 is divided into four partial bands #1 to #4.

The UL grant 301b includes sub UL grants 301ba to 301bd.

The sub UL grants 301ba to 301bd are corresponding to the partial bands #1 to #4, respectively. Moreover, information, which is independent of contents set and updated in the other sub UL grants, is set and updated in the sub UL grant 301bb. On the other hand, information, which is independent of contents of the sub UL grant 301bb and which is common to the sub UL grants 301ba, 301bc, and 301bd, is set and updated in the sub UL grants 301ba, 301bc, and 301bd.

In order to set and update the UL grant 301b, the UL grant determination unit 113, which is illustrated in FIG. 2, prescribes to update each of the sub UL grants 301ba to 301bd in the above-mentioned UL grant update information. Moreover, the UL grant determination unit 113 makes the information which indicates the contents to be set and updated in the sub UL grant 301bb, and the common information to be set and updated in the sub UL grants 301ba, 301bc, and 301bd embedded in the above-mentioned UL grant update information.

In the UL grant 301b, it is possible to optionally set each of the contents of the sub UL grant 301bb, and the contents of the sub UL grants 301ba, 301bc, and 301bd.

FIG. 15 illustrates an example that the frequency band 391 is divided into four partial bands #1 to #4, but the division number of the frequency band is optional.

Moreover, number and positions of the partial bands, whose sub UL grants have the common contents, are optional.

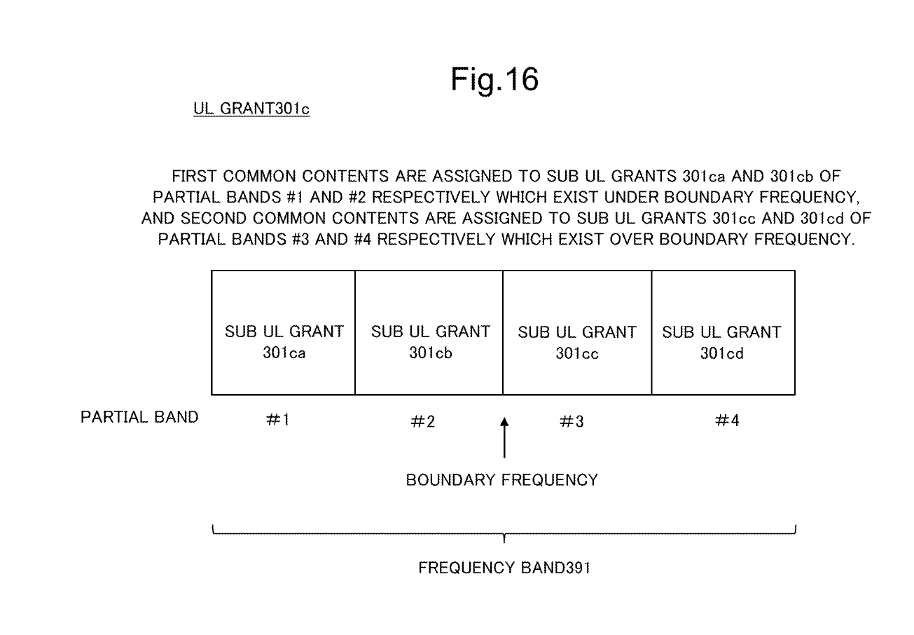

FIG. 16 is an image diagram illustrating the UL grant 301c which is an example of the UL grant in which information assigned to the sub UL grant existing under a boundary frequency is different from information assigned to the sub UL grant existing over the boundary frequency.

The frequency band 391 is divided into four partial bands #1 to #4.

In the UL grant 301c, first common contents are assigned to the sub UL grants 301ca and 301cb which are the sub UL grants of the partial bands existing under the boundary frequency. In the UL grant 301c, second common contents are assigned to the sub UL grants 301cc and 301cd which are the sub UL grants of the partial bands existing over the boundary frequency.

In order to set and update the UL grant 301b, the UL grant determination unit 113 prescribes to update each of the sub UL grants 301ca to 301cd in the above-mentioned UL grant update information. Moreover, the UL grant determination unit 113 makes first information which indicates the contents to be set and updated in the sub UL grant of the partial band existing under the boundary frequency, and second information which indicates the contents to be set and updated in the sub UL grant of the partial band existing over the boundary frequency embedded in the above-mentioned UL grant update information.

In the UL grant 301b, it is possible to optionally set each of the contents of the sub UL grant of the partial band existing under the boundary frequency, and the contents of the sub UL grant of the partial band existing over the boundary frequency.

FIG. 16 illustrates an example that the frequency band 391 is divided into four partial bands #1 to #4, but the division number of the frequency band is optional.

Moreover, number of the partial bands over the boundary frequency is optional. Number of the partial bands under the boundary frequency is equivalent to a number which is obtained by subtracting the number of the partial bands existing over the boundary frequency from the division number.

FIG. 17 is an image diagram illustrating the UL grant 301d which is an example of the UL grant in which the partial band for TPC command and the partial band for MCS are set separately.

The frequency band is divided into partial bands for TPC command # T1 to # T4.

Moreover, the frequency band is divided into partial bands for MCS # M1 to # T6.

The UL grant 301d includes a TPC command 306 and a MCS 311.

The TPC command 306 includes sub TPC commands 306a to 306d. The sub TPC commands 306a to 306d are corresponding to the partial bands for TPC command # T1 to # T4, respectively.

The MCS 311 includes sub MCSs 311a to 311f. The sub MCSs 311a to 311f are corresponding to the partial bands for MCS # M1 to # M6, respectively.

In order to set and update the UL grant 301d, the division unit 112, which is illustrated in FIG. 2, sets the partial bands for TPC command # T1 to # T4, and the partial bands for MCS # M1 to # M6.

Then, the path loss derivation unit 221, which is illustrated in FIG. 3, derives the path losses of each partial band for TPC command and each partial band for MCS.

Moreover, the PHR derivation unit 226, which is illustrated in FIG. 3, derives PHRs of each of the partial bands for TPC command, and the partial bands for MCS.

Then, the UL grant determination unit 113, which is illustrated in FIG. 2, makes information, which indicates to update the sub TPC command of each partial band for TPC command, and the sub MCS of each partial band for MCS, embedded in the UL grant update information. Furthermore, the UL grant determination unit 113 makes the updated sub TPC command of each partial band for TPC command, and the updated sub MCS of each partial band for MCS embedded in the UL grant update information.

In the UL grant 301d, it is possible to set the sub TPC command and the sub MCS in the partial bands whose bandwidths are different from each other.

Here, the UL grant 301d is an example of the UL grant whose frequency band 391 is divided into four partial bands for TPC command and six partial bands for MCS. The division number which is number of the partial bands for TPC command into which the frequency band 391 is divided, and the division number which is number of the partial bands for MCS into which the frequency band 391 is divided are optional.

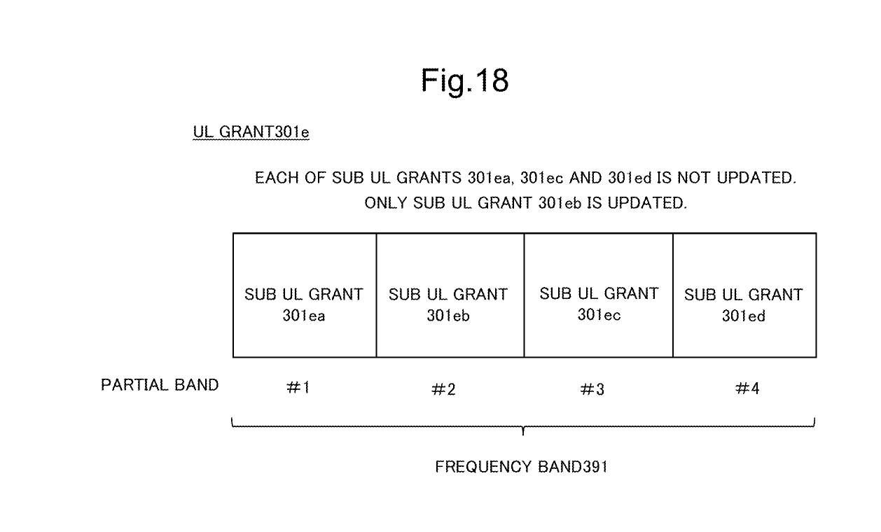

FIG. 18 is an image diagram illustrating a UL grant 301e which is an example of the UL grant in which only the predetermined sub UL grant is updated.

The frequency band 391 is divided into four partial bands #1 to #4.

In the UL grant 301e, predetermined contents are set beforehand in each of sub UL grants 301ea, 301ec, and 301ed. Moreover, the contents of each of the sub UL grants 301ea, 301ec, and 301ed are not updated based on the UL grant update information which the UL grant determination unit 113 generates.

On the other hand, contents of a sub UL grant 301eb are updated based on the UL grant update information.

In order to update the UL grant 301e, the UL grant determination unit 113, which is illustrated in FIG. 2, prescribes to update only the sub UL grant 301eb in the above-mentioned UL grant update information. Information, which indicates to update only the sub UL grant 301eb, is expressed by presence of a bit which indicates permission to update only the partial band #2. Alternatively, the information which indicates to update only the sub UL grant 301eb is expressed, for example, by absence of a bit, which indicates prohibition of the update, in only the partial band #2.

Furthermore, the UL grant determination unit 113 makes the information, which indicates to update the sub UL grant 301eb, embedded in the above-mentioned UL grant update information.

In the UL grant 301e, it is possible to update only the sub UL grant of the partial band which is required to be updated.

Here, FIG. 18 is an example that the frequency band is divided into four partial bands #1 to #4, but the division number of the frequency band is optional.

Moreover, positions and number of the partial bands, which are not updated, are optional.

Moreover, a plurality of the partial bands, which should be updated, may be updated by common information.

In the above-mentioned explanation, the example that the base station 101, which is illustrated in FIG. 1, sets the division information, and transmits the division information to the mobile station 201 has been explained. However, the mobile station 201 may carry out derivation of the above-mentioned division information which is independent of derivation of the division information carried out by the base station 101.

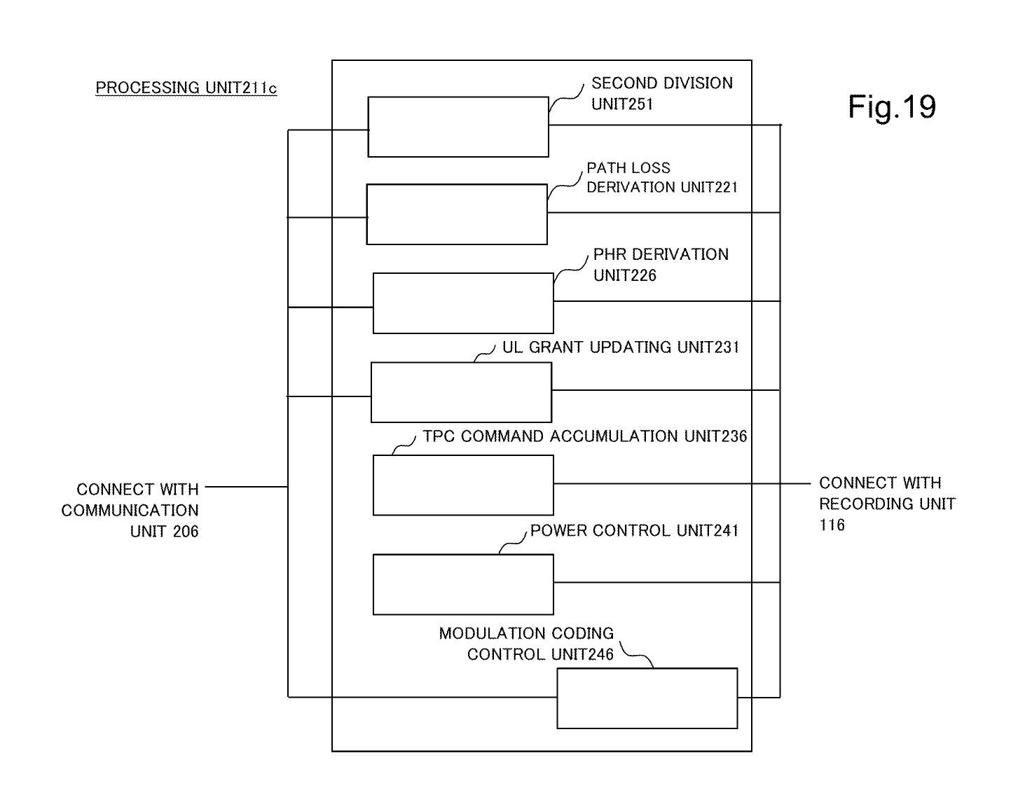

FIG. 19 is a conceptual diagram illustrating a configuration of a processing unit 211c which is an example of the processing unit 211 of the mobile station 201 illustrated in FIG. 1 and which can derive the division information that is independent of derivation of the division information carried out by the base station 101.

The processing unit 211c includes a second division unit 251 in addition to each component of the processing unit 211a which is illustrated in FIG. 3.

The second division unit 251 divides a frequency band which is read from the recording unit 216, and derives a plurality of partial bands. The recording unit 216 holds the frequency band, and a rule on the frequency division, which is carried out by the division unit 112 illustrated in FIG. 2, in advance. Then, the second division unit 251 carries out the frequency division according to the rule. Accordingly, the partial band which the second division unit 251 derives is identical with the partial band which the division unit 112 derives.

The division unit 112 makes the recording unit 116 record the division information which is information indicating each partial band.

The base station 101 may not transmit the division information to the mobile station 201 (illustrated in FIG. 1) which includes the processing unit 211c.

Then, if necessary, each component of the processing unit 211c carries out each work based on the division information which the second division unit 251 makes the recording unit 216 record.

Explanation on each component of the processing unit 211c except for the above mention is the same as explanation on each component of the above-mentioned processing unit 211a which is illustrated in FIG. 3. However, when the above-mentioned explanation, and the explanation on each component of the processing unit 211a illustrated in FIG. 3 are inconsistent with each other, the above-mentioned explanation on the processing unit 211c is given priority over the explanation on the processing unit 211a.

With the processing unit 211c, it is possible to omit transmission of division information from the base station 101 to the mobile station 201.

[Effect]

Deviation of the path loss (actual path loss) at the frequency, which is actually used in communication, from the path loss which is derived (derived path loss) increases as the frequency bandwidth becomes wide. When the transmission power and the modulation coding are controlled based on the UL grant which is derived from the derived path loss having the difference from the actual path loss, accuracy of the control becomes low.

The communication system of the present example embodiment divides the frequency band which is used in the wireless communication between the base station and the mobile station. Then, the communication system carries out the transmission power control and the modulation coding control based on the UL grant which is derived from the path loss derived for each of the partial bands which are the frequency bands generated by the division.

Since each partial band is narrower than the frequency band used in the wireless communication, the difference between the actual path loss and the derived path loss is small. This means that the communication system can improve accuracy of the control by using the UL grant which is derived from the derived path loss.

That is, the above-mentioned communication system carries out the power control and the modulation coding control more appropriately.

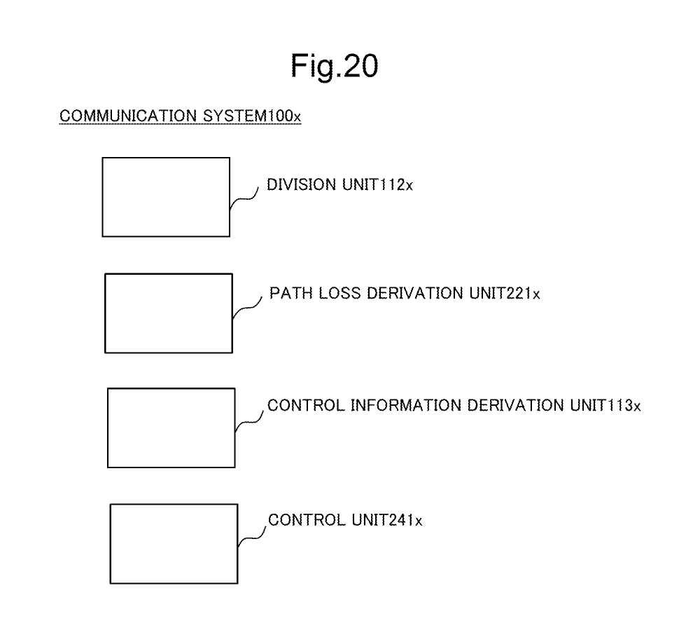

FIG. 20 is a conceptual diagram illustrating a configuration of a communication system 100x which is a minimum configuration of the communication system according to the present example embodiment.

The communication system 100x includes a division unit 112x, a path loss derivation unit 221x, a control information derivation unit 113x, and a control unit 241x.

The division unit 112x divides a frequency band which is assigned to wireless communication carried out between first communication equipment, and second communication equipment, and generates a partial band which is a frequency band generated by the division.

The path loss derivation unit 221x derives a propagation loss of at least one partial band which relates to the above-mentioned communication.

The control information derivation unit 113x derives control information from the propagation loss.

The control unit 241x carries out the transmission power control and/or the modulation coding control based on the above-mentioned control information.

Deviation of the propagation loss (actual path loss) at the frequency, which is used actually in the communication, from the propagation loss (derived path loss) which is derived becomes large as the frequency bandwidth becomes wide. When the transmission power and the modulation coding are controlled based on the control information which is derived from the derived path loss having the difference from the actual path loss, accuracy of the control becomes low.

The communication system 100x divides the frequency band which is used in the wireless communication between the first communication equipment and the second communication equipment. Then, the communication system 100x carries out the transmission power control and the modulation coding control based on the control information derived from the derived propagation loss of each partial band which is the frequency band generated by the division.

Since each partial band is narrower than the above-mentioned frequency band used in the wireless communication, the difference between the actual path loss and the derived path loss is small. This means that it is possible to improve accuracy of the control by using the control information which is derived from the derived path loss.

That is, the communication system 100x carries out the power control and the modulation coding control more appropriately.

Therefore, by virtue of the above-mentioned configuration, the communication system 100x brings about an effect of carrying out the power control and the modulation coding control more appropriately.

Hereinbefore, each example embodiment of the present invention has been explained, but the present invention is not limited to the above-mentioned example embodiment. It is possible to add further transformation, replacement, and adjustment without departing from the basic technical-idea of the present invention. For example, the configuration of the element which is illustrated in each drawing is an example provided for helping understand the present invention, and the configuration of the element is not limited to the configurations illustrated in these drawings.

The whole or part of the example embodiments disclosed above can be described as, but not limited to, the following supplementary notes.

(Supplementary Note 1)

A communication system, comprising:

a division unit that divides a frequency band assigned to wireless communication which is carried out between first communication equipment and second communication equipment, and generates a partial band which is a frequency band generated by the division;

a path loss derivation unit that derives a propagation loss, which relates to the communication, in at least one of the partial bands;

a control information derivation unit that derives control information from the propagation loss; and

a control unit that carries out transmission power control and/or modulation coding control based on the control information.

(Supplementary Note 2)

The communication system according to supplementary note 1, wherein

the propagation loss is a path loss that is described in Third Generation Partnership Project Technical Specification 36.213.

(Supplementary Note 3)

The communication system according to supplementary note 1 or supplementary note 2, wherein

the first communication equipment is a base station, and the second communication equipment is a mobile station.

(Supplementary Note 4)

The communication system according to any one of supplementary note 1 to supplementary note 3, wherein

the path loss derivation unit derives the propagation loss of each partial band.

(Supplementary Note 5)

The communication system according to any one of supplementary note 1 to supplementary note 4, wherein

the first communication equipment includes the division unit.

(Supplementary Note 6)

The communication system according to supplementary note 5, wherein

the second communication equipment includes the path loss derivation unit.

(Supplementary Note 7)

The communication system according to supplementary note 6, wherein

the first communication equipment includes the control information derivation unit.

(Supplementary Note 8)

The communication system according to supplementary note 7, wherein

the second communication equipment transmits derivation information, which is information derived from the propagation loss, to the first communication equipment, and the control information derivation unit derives the control information based on the derivation information.

(Supplementary Note 9)

The communication system according to supplementary note 8, wherein

the derivation information is Power Headroom that is described in Third Generation Partnership Project Technical Specification 36.213.

(Supplementary Note 10)

The communication system according to any one of supplementary note 1 to supplementary note 9, wherein

the control information is included in a UP Link grant that is described in Third Generation Partnership Project Technical Specification 36.213.

(Supplementary Note 11)

The communication system according to supplementary note 10, wherein

the control information includes an accumulation value of a Transmit Power Control command that is described in Third Generation Partnership Project Technical Specification 36.213.

(Supplementary Note 12)

The communication system according to supplementary note 10 or supplementary note 11, wherein

the control information includes Modulation and Coding Scheme which is described in Third Generation Partnership Project Technical Specification 36.213.

(Supplementary Note 13)

The communication system according to any one of supplementary note 1 to supplementary note 12, wherein

the control information relates to transmission which is carried out by the second communication equipment.

(Supplementary Note 14)

The communication system according to supplementary note 13, wherein

the second communication equipment holds the control information.

(Supplementary Note 15)

The communication system according to supplementary note 13 or supplementary note 14, wherein

the second communication equipment includes the control unit.

(Supplementary Note 16)

The communication system according to any one of supplementary note 1 to supplementary note 15, wherein

the second communication equipment updates the control information, which the second communication equipment holds, based on update information that the first communication equipment transmits.

(Supplementary Note 17)

The communication system according to supplementary note 16, wherein

the update information includes contents to make a portion of the control information, which relates to each of the partial bands, set or updated individually.

(Supplementary Note 18)

The communication system according to supplementary note 16, wherein

the update information includes contents to make a plurality of portions out of the portions of the control information, each of which relates to each of the partial bands, set or updated in such a way that the plural portions may be common information.

(Supplementary Note 19)

The communication system according to supplementary note 16 or supplementary note 18, wherein

the update information includes contents to make only some portions out of portions of the control information, each of which relates to each of the partial bands, set or updated.

(Supplementary Note 20)

The communication system according to any one of supplementary note 16 to supplementary note 19, wherein

the update information includes contents to set or update a Transmit Power Control command that is included in the control information and is described in Third Generation Partnership Project Technical Specification 36.213, and Modulation and Coding Scheme that is included in the control information.

(Supplementary Note 21)

The communication system according to any one of supplementary note 16 to supplementary note 20, wherein

the update information includes contents to individually set or update a Transmit Power Control command that is included in the control information and is described in Third Generation Partnership Project Technical Specification 36.213, and Modulation and Coding Scheme that is included in the control information.

(Supplementary Note 22)

The communication system according to any one of supplementary note 16 to supplementary note 21, wherein

a first partial band group that includes the partial band relating to a Transmit Power Control command, and a second partial band group that includes the partial band relating to Modulation and Coding Scheme are different from each other.

(Supplementary Note 23)

The communication system according to any one of supplementary note 1 to supplementary note 22, wherein

the second communication equipment includes a second division unit that generates the partial band.

(Supplementary Note 24)

A communication control method, comprising:

dividing a frequency band assigned to wireless communication that is carried out between first communication equipment and second communication equipment;

generating a partial band that is a frequency band generated by the division;

deriving a propagation loss, which relates to the communication, in at least one of the partial bands;

deriving control information from the propagation loss; and

carrying out transmission power control and/or modulation coding control based on the control information.

### REFERENCE SIGNS LIST

100 and 100x Communication system
101 Base station
106 and 206 Communication unit
111, 111a, 211, 211a, 211b, and 211c Processing unit
112 and 112x Division unit
113 UL grant determination unit
113x Control information derivation unit
116 and 216 Recording unit
201 Mobile station
221 Path loss derivation unit
2211 First path loss derivation unit
221N Nth path loss derivation unit
221x Path loss derivation unit
226 PHR derivation unit
2261 First PHR derivation unit
226N Nth PHR derivation unit
231 UL grant updating unit
236 TPC command accumulation unit
2361 First TPC command accumulation unit
236N Nth TPC command accumulation unit
241 Power control unit
241x Control unit
246 Modulation coding control unit
251 Second division unit
301a, 301b, 301c, 301d, and 301e UL grant
301aa, 301ab, 301ac, 301ad, 301ba, 301bb, 301bc, 301bd, 301ca, 301cb, 301cc, 301cd, 301ea, 301eb, 301ec, and 301ed Sub UL grant
306 TPC command
306a, 306b, 306c, and 306d Sub TPC command
311 MCS
311a, 311b, 311c, 311d, 311e, and 311f Sub MCS
391 Frequency band
#1, #2, #3, and #4 Partial band
# T1, # T2, # T3, and # T4 Partial band for TPC command
# M1, # M2, # M3, # M4, # M5, and # M6 Partial band for MCS The previous description of embodiments is provided to enable a person skilled in the art to make and use the present invention. Moreover, various modifications to these example embodiments will be readily apparent to those skilled in the art, and the generic principles and specific examples defined herein may be applied to other embodiments without the use of inventive faculty. Therefore, the present invention is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution. While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

What is claimed is:

1. A communication system, comprising:
a division circuit that divides a frequency band assigned to wireless communication which is carried out between first communication equipment and second communication equipment, and generates a partial band which is a frequency band generated by the division;
a path loss derivation circuit that derives a propagation loss, which relates to the communication, in at least one of partial bands;
a control information derivation circuit that derives control information from the propagation loss; and
a controller that carries out transmission power control and/or modulation coding control based on the control information.

2. The communication system according to claim 1, wherein
the propagation loss is a path loss that is described in Third Generation Partnership Project Technical Specification 36.213.

3. The communication system according to claim 1, wherein
the first communication equipment is a base station, and the second communication equipment is a mobile station.

4. The communication system according to claim 1, wherein
the path loss derivation circuit derives the propagation loss of each partial band.

5. The communication system according to claim 1, wherein
the first communication equipment includes the division circuit.

6. The communication system according to claim 5, wherein
the second communication equipment includes the path loss derivation circuit.

7. The communication system according to claim 6, wherein
the first communication equipment includes the control information derivation circuit.

8. The communication system according to claim 7, wherein
the second communication equipment transmits derivation information, which is information derived from the propagation loss, to the first communication equipment, and the control information derivation circuit derives the control information based on the derivation information.

9. The communication system according to claim 1, wherein
the control information relates to transmission which is carried out by the second communication equipment.

10. The communication system according to claim 9, wherein
the second communication equipment holds the control information.

11. The communication system according to claim 9, wherein
the second communication equipment includes the controller.

12. The communication system according to claim 1, wherein
the second communication equipment updates the control information, which the second communication equipment holds, based on update information that the first communication equipment transmits.

13. The communication system according to claim 12, wherein
the update information includes contents to make a portion of the control information, which relates to each of the partial bands, set or updated individually.

14. The communication system according to claim 13, wherein
the update information includes contents to make a plurality of portions out of portions of the control information, each of which relates to each of the partial bands, set or updated in such a way that the plural portions may be common information.

15. The communication system according to claim 12, wherein
the update information includes contents to make only some portions out of the portions of the control information, each of which relates to each of the partial bands, set or updated.

16. The communication system according to claim 12, wherein
the update information includes contents to set or update a Transmit Power Control command that is included in the control information and is described in Third Generation Partnership Project Technical Specification 36.213, and Modulation and Coding Scheme that is included in the control information.

17. The communication system according to claim 12, wherein
the update information includes contents to individually set or update the Transmit Power Control command that is included in the control information and is described in Third Generation Partnership Project Technical Specification 36.213, and Modulation and Coding Scheme that is included in the control information.

18. The communication system according to claim 12, wherein
a first partial band group that includes the partial band relating to the Transmit Power Control command, and a second partial band group that includes the partial band relating to Modulation and Coding Scheme are different each other.

19. The communication system according to claim 1, wherein
the second communication equipment includes a second division circuit that generates the partial band.

20. A communication control method, comprising:
dividing a frequency band assigned to wireless communication that is carried out between first communication equipment and second communication equipment;
generating a partial band that is a frequency band generated by the division;
deriving a propagation loss, which relates to the communication, in at least one of partial bands;
deriving control information from the propagation loss; and
carrying out transmission power control and/or modulation coding control based on the control information.
